(19) United States
(12) Patent Application Publication
(10) Pub. No.: US 2004/0167786 A1
(43) Pub. Date: Aug. 26, 2004

(54) System for optimizing selection of a college or a university and a method for utilizing the system provided by a program

(76) Inventor: John J. Grace, Lakewood, CO (US)

Correspondence Address: Charles E. Baxley, Hart, Baxley, Daniels & Holton, Fifth Floor, 59 John Street, New York, NY, 10038, US

(21) Appl. No.: 10/045,357

(22) Filed: Mar. 8, 2002

(51) Int. Cl. G06F 17/60

(52) U.S. Cl. 705/1

(57) ABSTRACT

A system for optimizing selection of a college or university and a method for utilizing the system. The system includes a college planning questionnaire, college planning questionnaire software, and a college action plan. The college planning questionnaire collects data about a student's interests, aptitude, abilities, talents, and school selection preferences, and information about finances of the family from both the parents and the student. The college planning questionnaire software assists the student in filling out the college planning questionnaire by helping identify appropriate areas of interest or specific college majors by interactively conducting a battery of tests in order to perform a thorough analysis of the likes and dislikes of the student. The college action plan is designed to take the family through the entire college transition process, is created by information from the college planning questionnaire, and includes only colleges and universities offering degrees in the student's selected major(s).

### BACKGROUND OF THE INVENTION

1. Field of the Invention

The present invention relates to a college planner. More particularly, the present invention relates to a system for optimizing selection of a college or a university and a method for utilizing the system provided by a program.

2. Description of the Prior Art

It is important to educate families about the high school to college transition so as to ensure that the student maximizes his/her opportunities during the high school to college transition process and guide students towards finding the best college or university for their specific situation. Additionally, it is important to educate families about academic and financial strategies and techniques that can make the transition between high school and college easier, not to mention make college more affordable.

Families must start planning for college as early as possible, because choosing the right high school classes is a critical step. Selective colleges consider every aspect of the high school career and can be stringent in their admission guidelines and requirements. Students must take into consideration appropriate college majors and corresponding careers and carry out specific activities each high school year to meet these considerations. Students must be prepared for the various examinations required by colleges and universities, such as the PSAT, the SAT I, and the ACT.

Parents must consider the financial aid process in order to enroll their student in college. A college will only offer incentives to a student when they know the student's abilities. Colleges truly appreciate being introduced to students that meet their criteria and fill a need at their school. Additionally, it is important to access merit-based financial aid. Merit-based financial aid can be awarded to students on the basis of their academic progress, state of residency, race, and/or artistic, athletic, or leadership qualifications. It does not take into account a family or student's income or assets.

It is important to consider the financial impact and quality of life issues involved with making a good career choice. Statistically, most students change their major three times over the course of their college career. Indecision can cost a student one, two, or more semesters of extra tuition and lost wages. This is extremely expensive when you consider the average cost of an American university is approximately $13,500 per year. Furthermore, a student's grades can suffer when they start taking classes in a major that doesn't match their true interests. This can lead to loss of scholarship monies or, even worse, a total disinterest in his/her pursuit of a college degree.

Thus, there exist a need for a college planner that provides professional and accurate college major and career evaluation, assists in finding colleges that match the student's major(s) or area of interest, reduces college semesters, and as a result thereof, decreases the overall cost of college and allows beginning the college career and earnings earlier, provides advice on how to maximize the families time and effort, provides specific information about colleges' admission requirements, faculty, activities, facilities, student body, and financial aid offerings, allows completion of all pertinent activities and events before the deadlines, reduces the entire families stress by taking control of the process, allows informed decisions about the financial aid package offered by each college to be made, allows beginning financial planning before it effects the potential financial aid package, arranges finances to maximize aid and minimize family contribution, ensures the financial aid officer is provided with of all important personal information that may increase a financial aid package, lowers overall college costs, provides a comprehensive solution for discovering all merit-aid awards available, provides accurate, up-to-date information about award requirements, availability etc., helps students to set goals in order to qualify for award funding by finding the best awards available at the selected colleges, provides a comprehensive test-preparation package for all standardized tests, arranges a specific tutorial program for each student's specific needs, uses actual tests while providing a detailed skills analysis focusing on improving the students weak skills, and provides colleges with an early look at the student's abilities, talents, interests, and accomplishments.

Numerous innovations for college planners have been provided in the prior art. Even though these innovations may be suitable for the specific individual purposes to which they address, however, they differ from the present invention and would therefore not be suitable for the purposes of the present invention as heretofore described, in that they do not teach a college planner that provides professional and accurate college major and career evaluation, assists in finding colleges that match the student's major(s) or area of interest, reduces college semesters, and as a result thereof, decreases the overall cost of college and allows beginning the college career and earnings earlier, provides advice on how to maximize the families time and effort, provides specific information about colleges' admission requirements, faculty, activities, facilities, student body, and financial aid offerings, allows completion of all pertinent activities and events before the deadlines, reduces the entire families stress by taking control of the process, allows informed decisions about the financial aid package offered by each college to be made, allows beginning financial planning before it effects the potential financial aid package, arranges finances to maximize aid and minimize family contribution, ensures the financial aid officer is provided with of all important personal information that may increase a financial aid package, lowers overall college costs, provides a comprehensive solution for discovering all merit-aid awards available, provides accurate, up-to-date information about award requirements, availability etc., helps students to set goals in order to qualify for award funding by finding the best awards available at the selected colleges, provides a comprehensive test-preparation package for all standardized tests, arranges a specific tutorial program for each student's specific needs, uses actual tests while providing a detailed skills analysis focusing on improving the students weak skills, and provides colleges with an early look at the student's abilities, talents, interests, and accomplishments..

### SUMMARY OF THE INVENTION

Accordingly, an object of the present invention is to provide a system for optimizing selection of a college or a university and a method for utilizing the system provided by a program that avoids the disadvantages of the prior art.

Another object of the present invention is to provide a system for optimizing selection of a college or a university and a method for utilizing the system provided by a program that is simple to use.

Briefly stated, still another object of the present invention is to provide a system for optimizing selection of a college or university and a method for utilizing the system provided by a program. The system includes a college planning questionnaire, college planning questionnaire software, and a college action plan. The college planning questionnaire collects data about a student's interests, aptitude, abilities, talents, and school selection preferences, and information about finances of the family from both the parents and the student. The college planning questionnaire software assists the student in filling out the college planning questionnaire by helping identify appropriate areas of interest or specific college majors by interactively conducting a battery of tests in order to perform a thorough analysis of the likes and dislikes of the student. The college action plan is designed to take the family through the entire college transition process, is created by information from the college planning questionnaire, and includes only colleges and universities offering degrees in the student's selected major(s).

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIGS. 1A-1DDD are a system chart of the system for optimizing selection of a college or a university of the present invention; and

FIGS. 2A-2CC are a process flow chart of the method of the present invention for utilizing the system for optimizing selection of a college or university of the present invention shown in FIGS. 1A-1DDD.

### LIST OF REFERENCE NUMERALS UTILIZED IN THE DRAWING

10 system of present invention for optimizing selection of college or university

12 college planning questionnaire

14 college planning questionnaire software

16 college action plan

18 parents section of college planning questionnaire 12

20 student section of college planning questionnaire 12

21 printable report of college planning questionnaire software 14

22 hard copy of college action plan 16

24 video of college action plan 16

26 test preparation system of college action plan 16

28 profile worksheet of college action plan 16

30 ten major sections of hard copy 22 of college action plan 16

32 action item checklist at end of each section of ten major sections 30 of hard copy 22 of college action plan 16

34 appendix of hard copy 22 of college action plan 16

36 two main sections of ten major sections 30 of hard copy 22 of college action plan 16

38 financial aid section of two main sections 36 of ten major sections 30 of hard copy 22 of college action plan 16

40 college selection section of two main sections 36 often major sections 30 of hard copy 22 of college action plan 16

42 list of college selection section 40 of two main sections 36 often major sections 30 of hard copy 22 of college action plan 16

44 two-page analysis of college selection section 40 of two main sections 36 of ten major sections 30 of hard copy 22 of college action plan 16

46 thirteen short sections of appendix 34 of hard copy 22 of college action plan 16

48 test preparation software of test preparation system 26 of college action plan 16

50 SAT I video of test preparation system 26 of college action plan 16

52 SAT I practice test booklet of test preparation system 26 of college action plan 16

### DETAILED DESCRIPTION OF THE PREFERRED EMBODIMENT

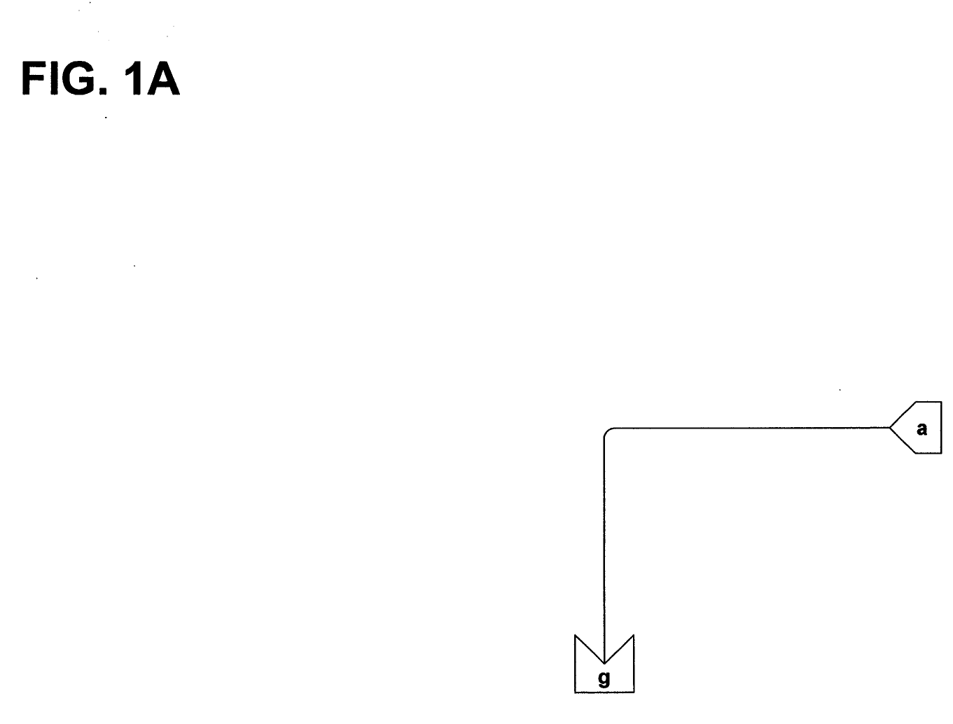

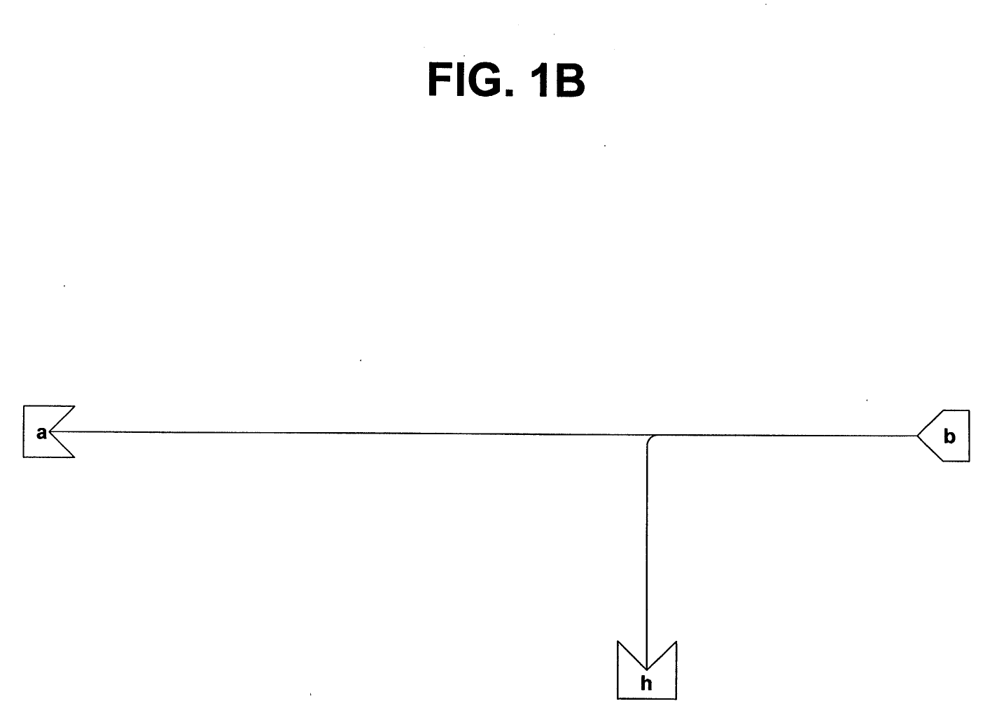

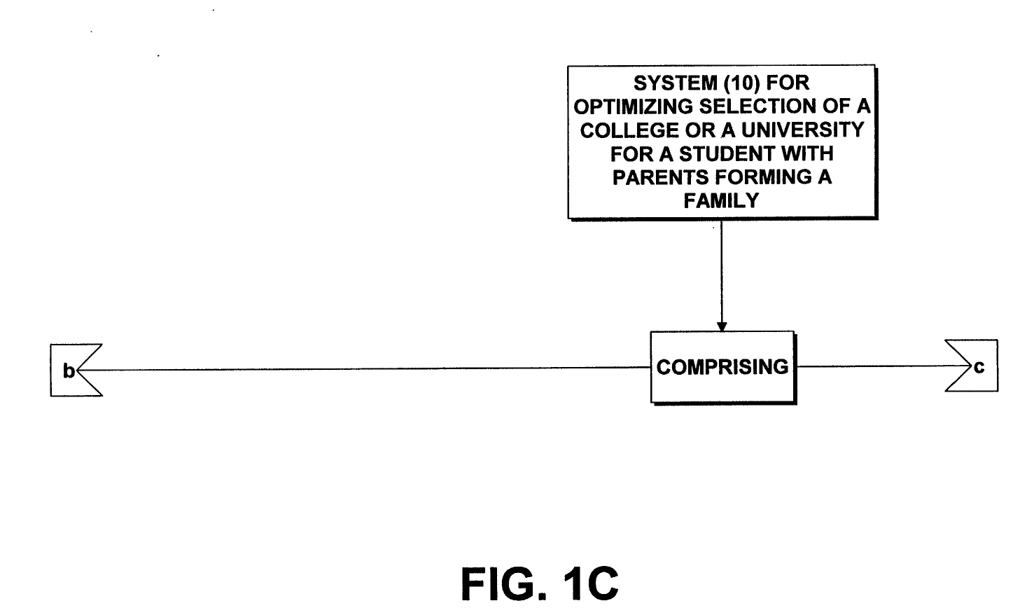

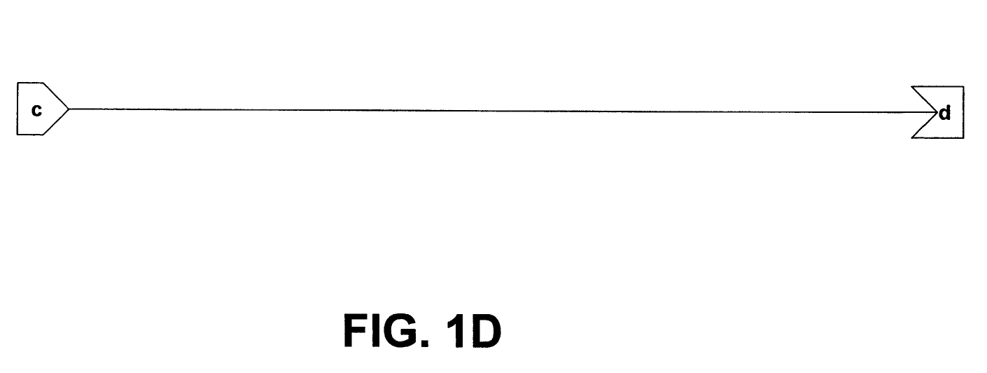

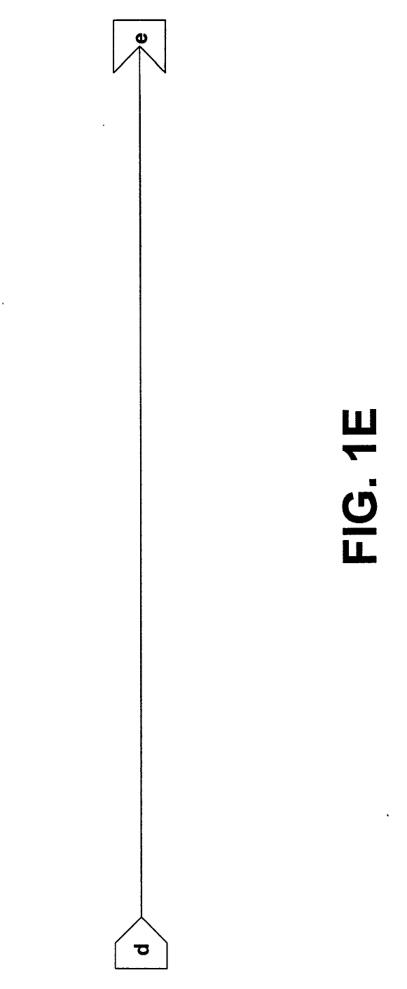

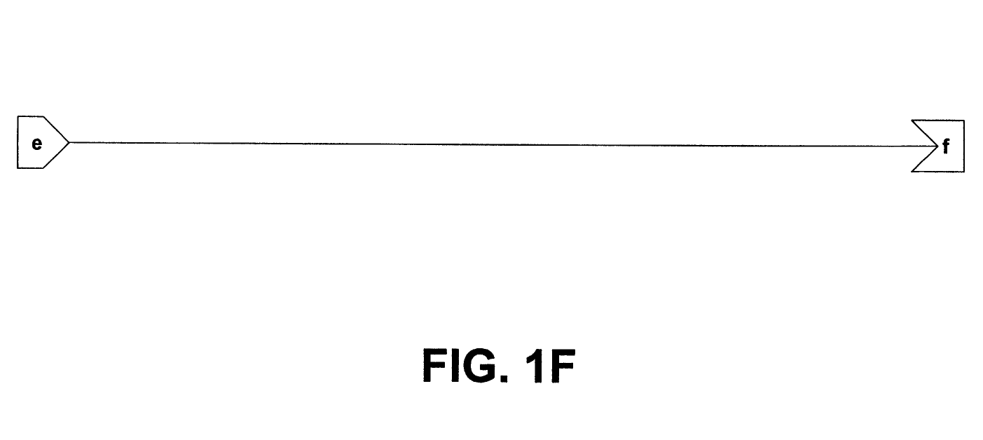

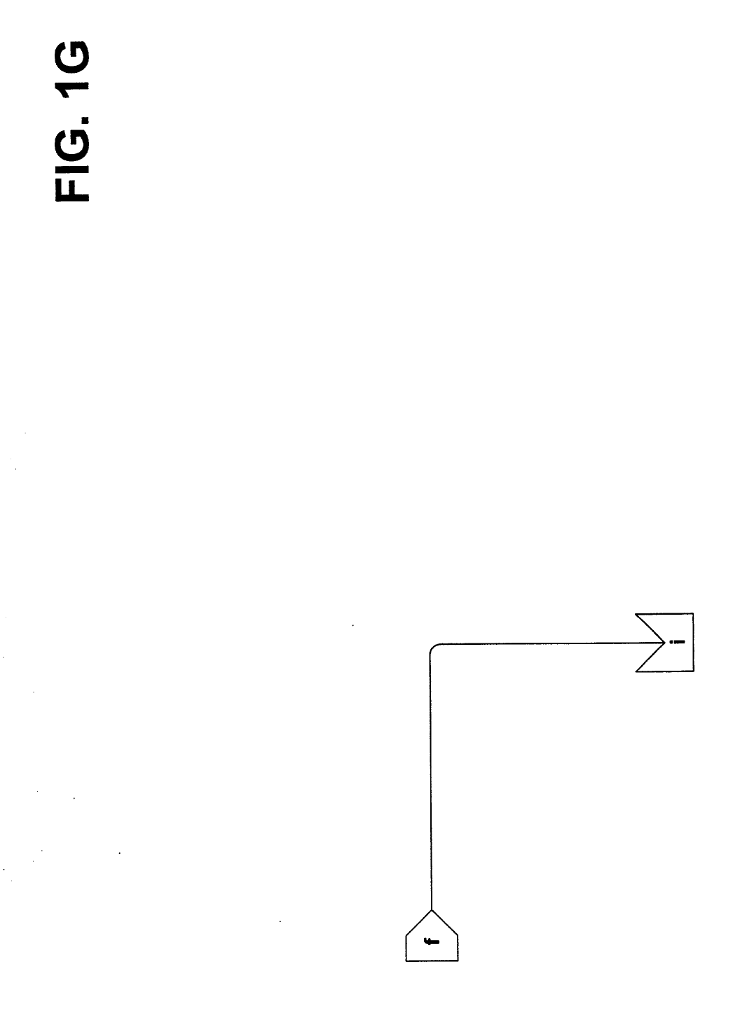

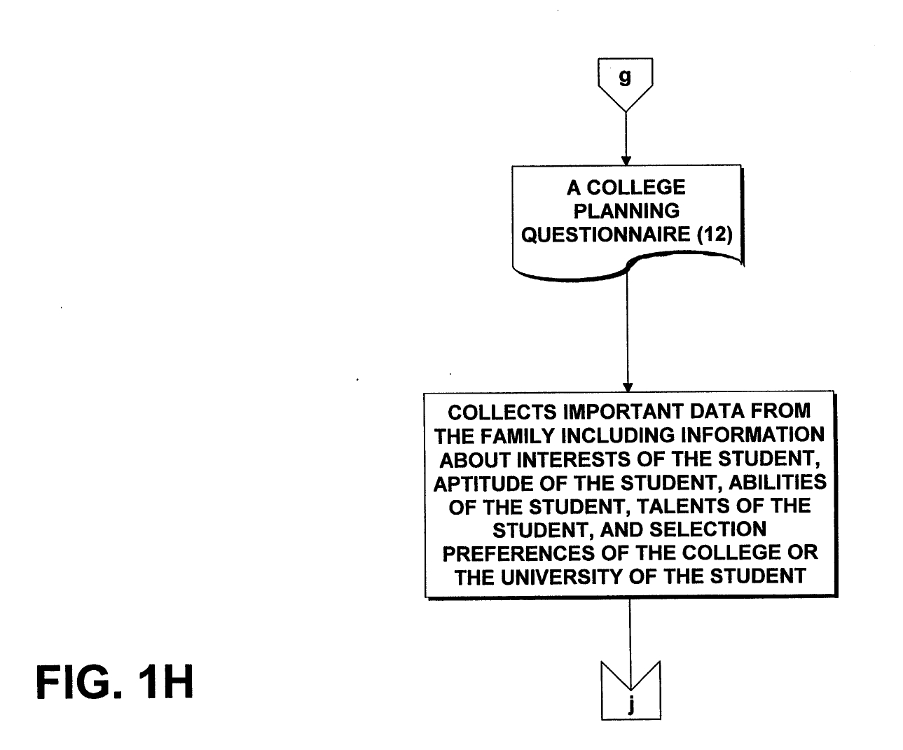

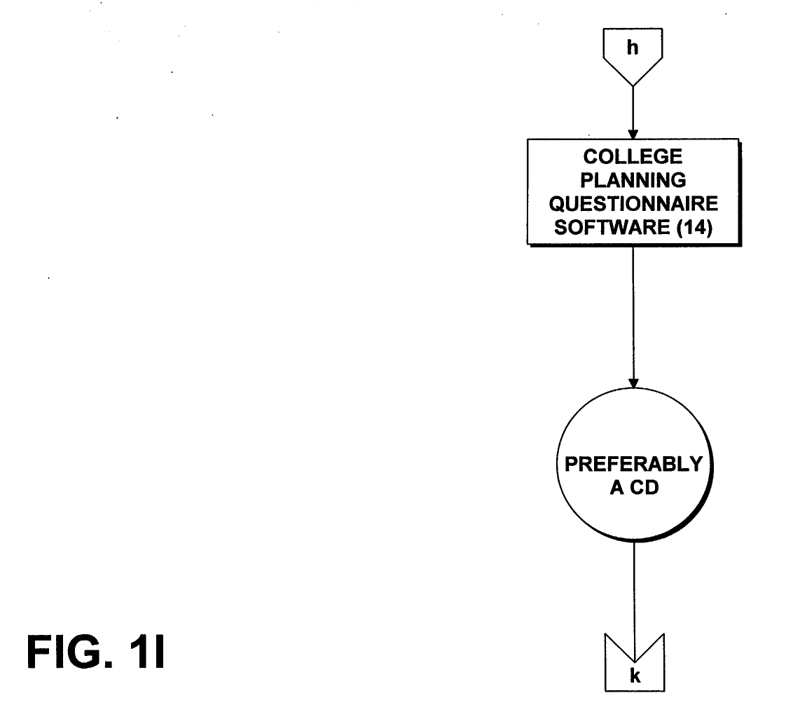

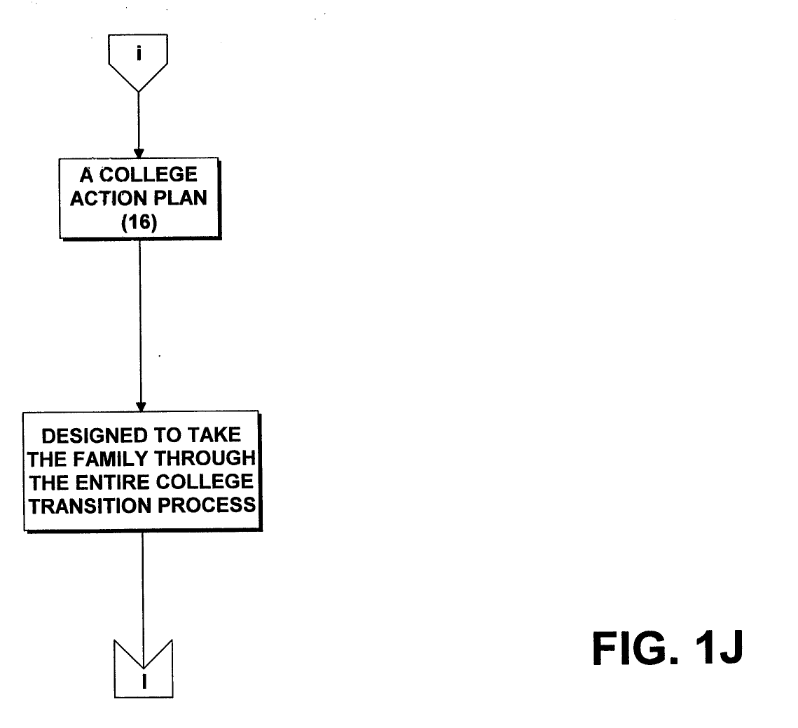

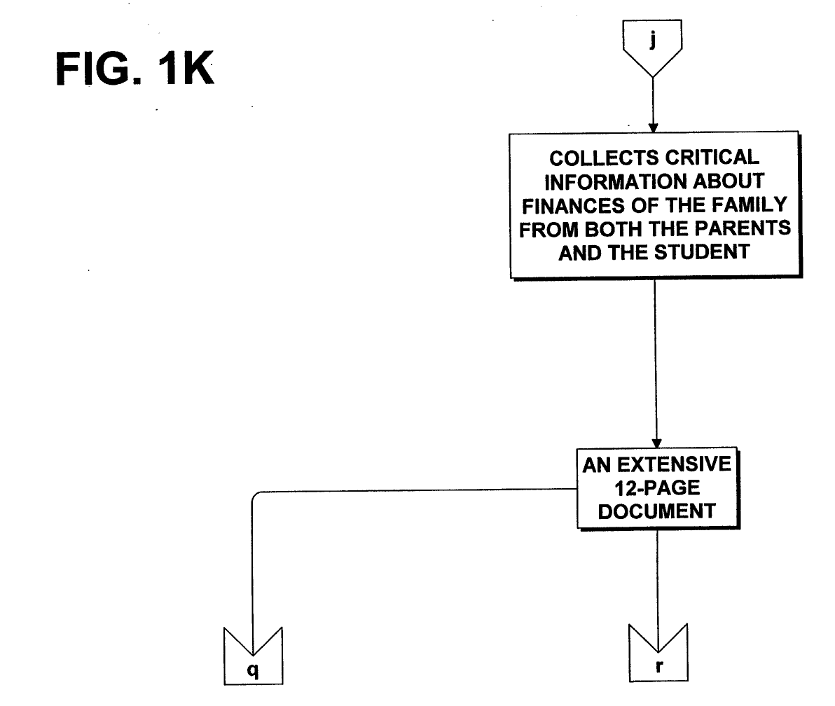

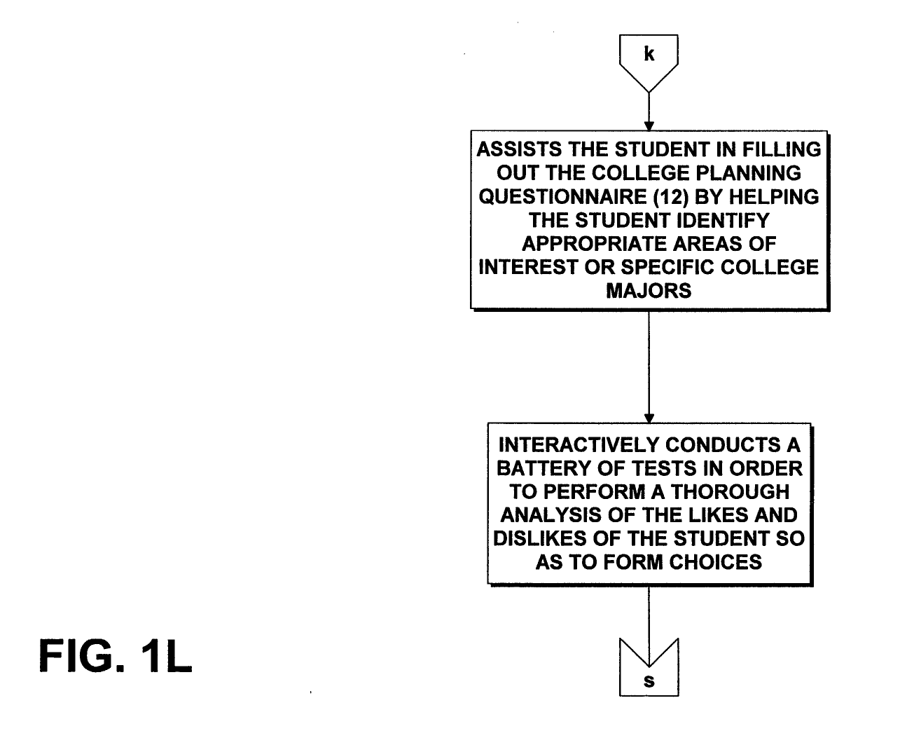

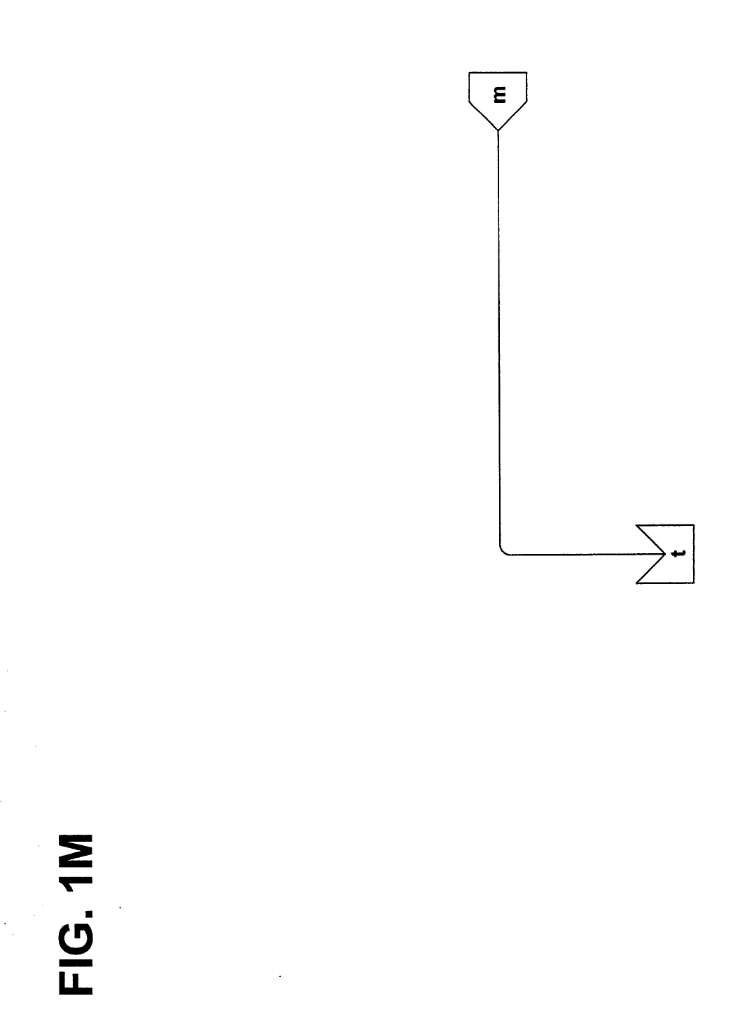

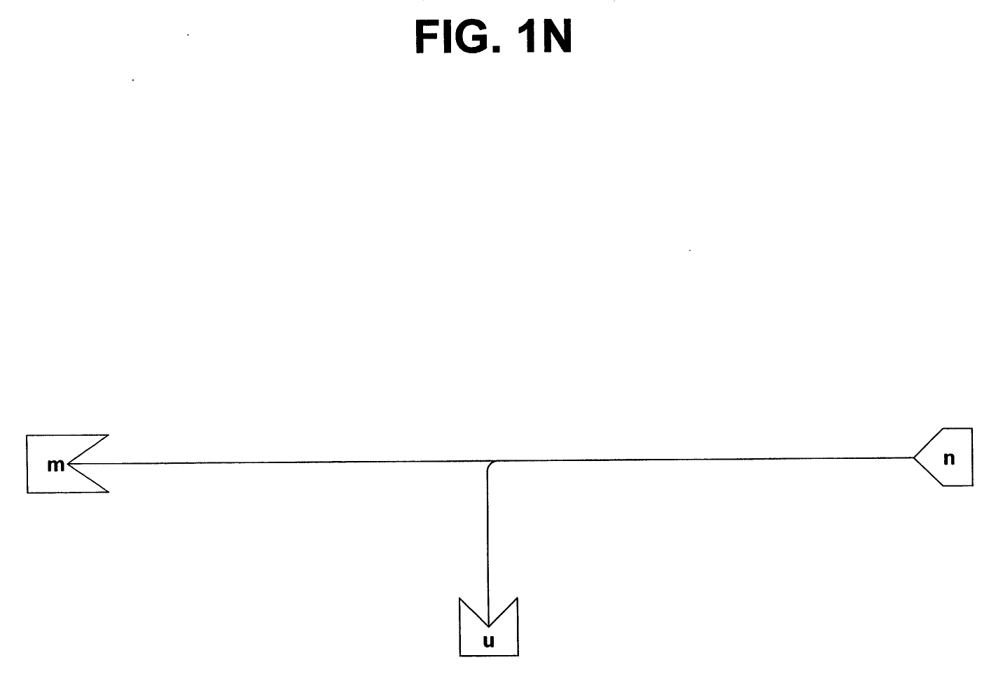

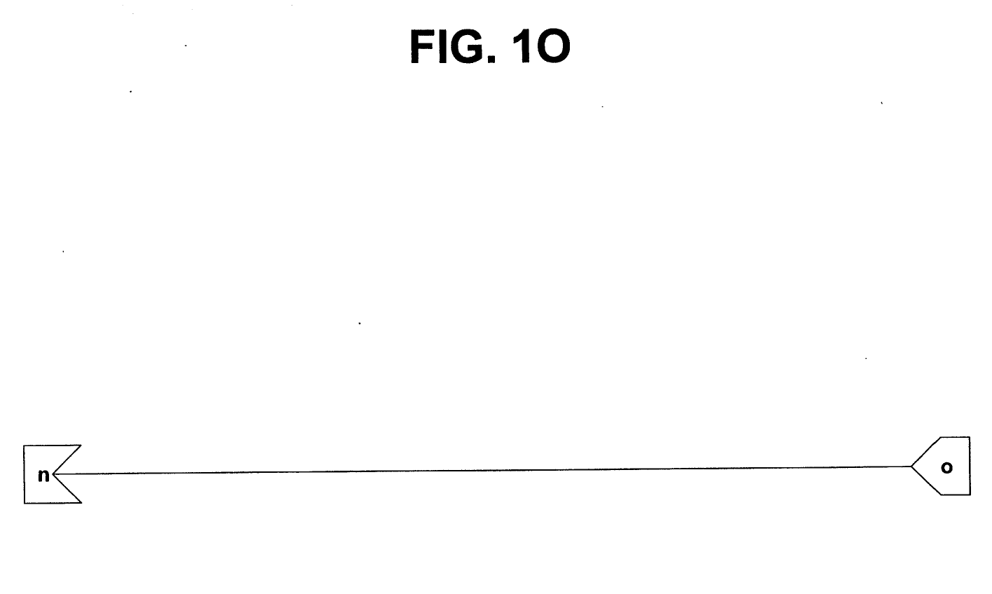

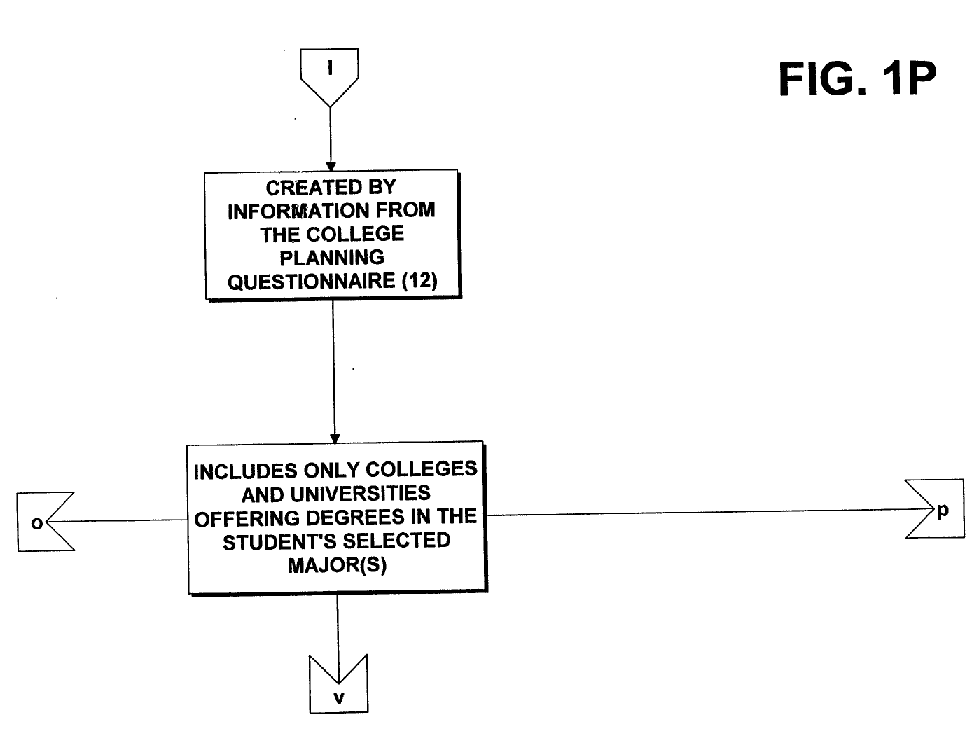

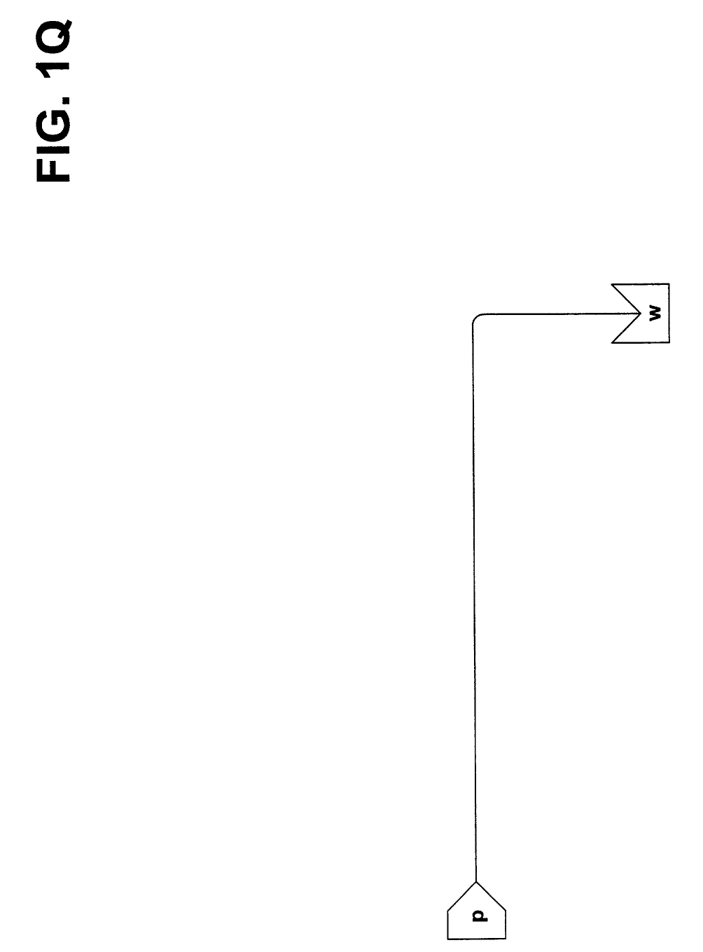

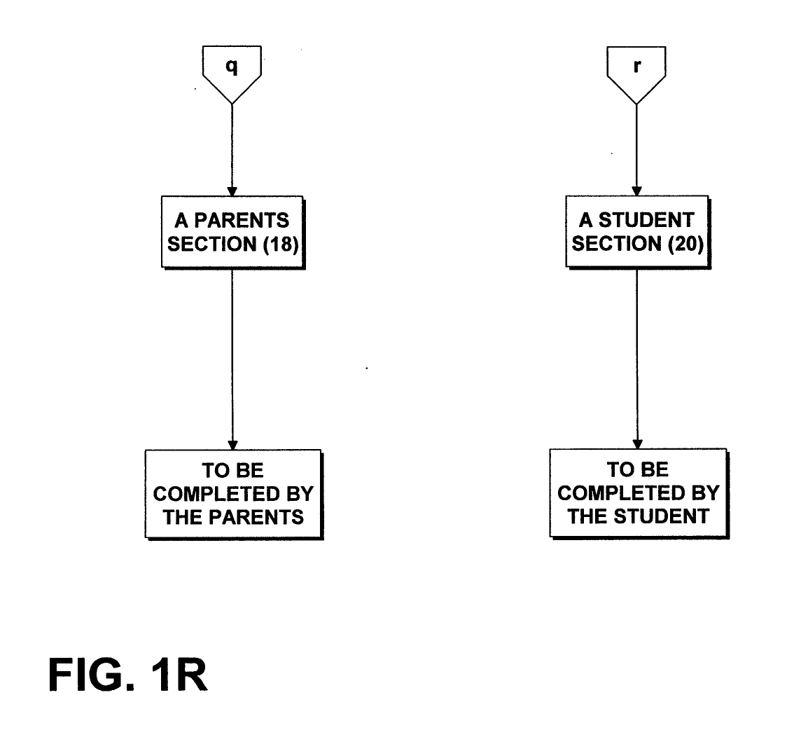

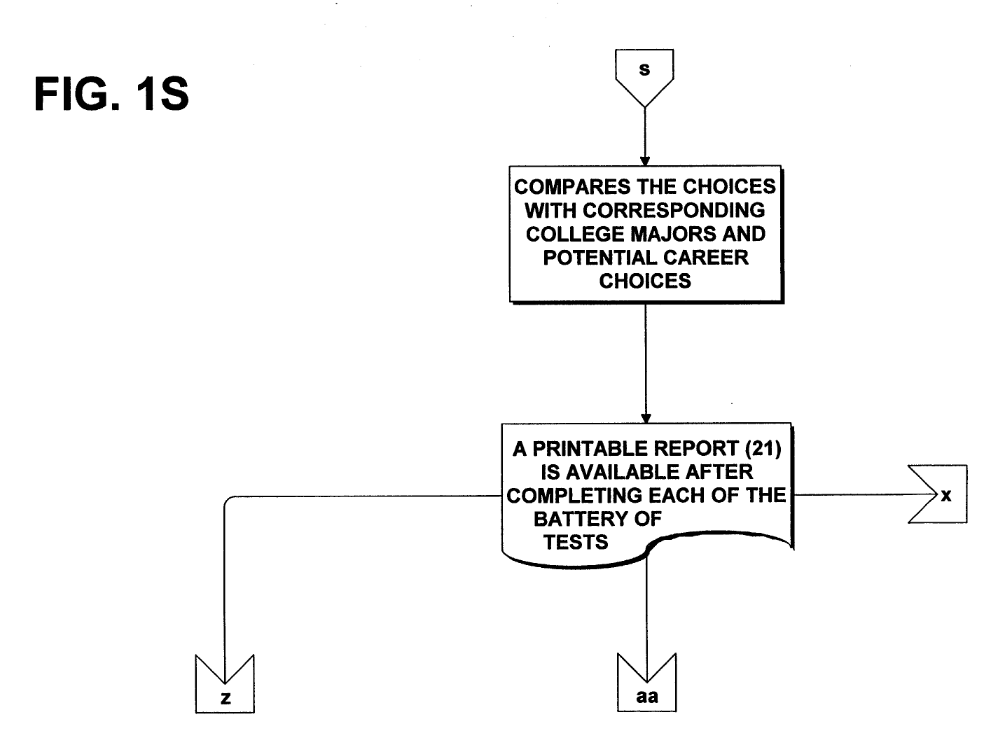

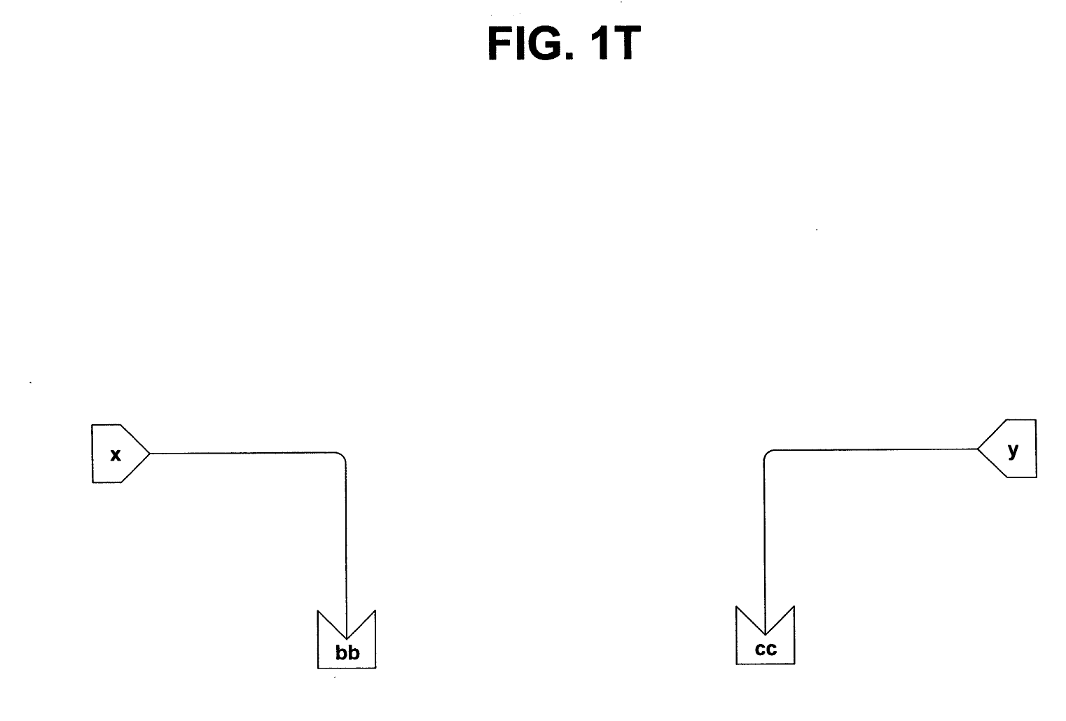

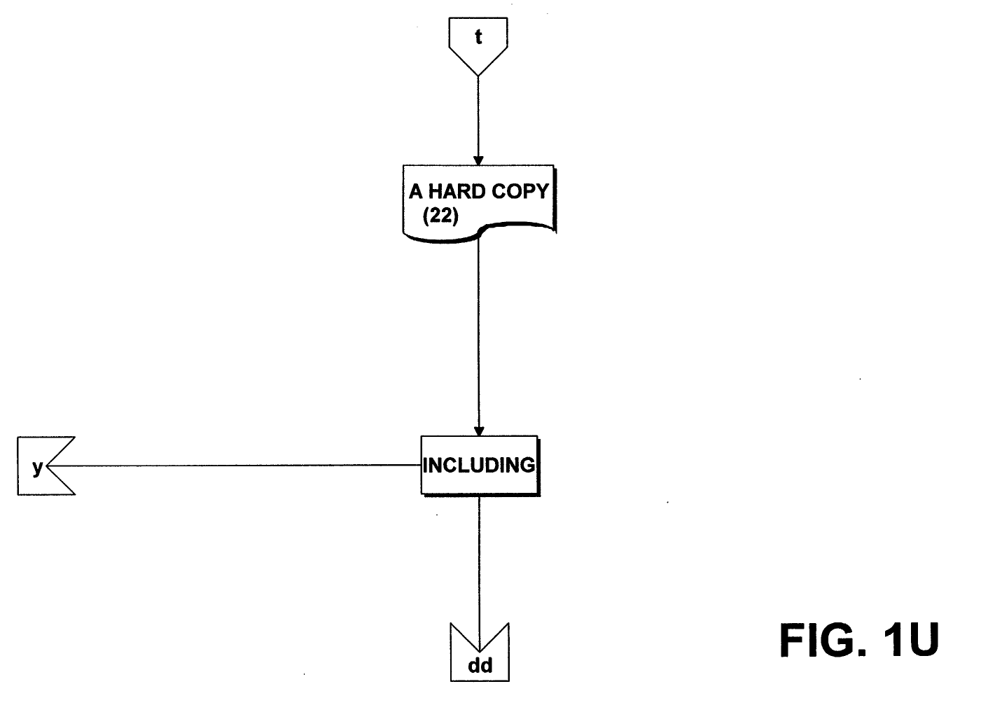

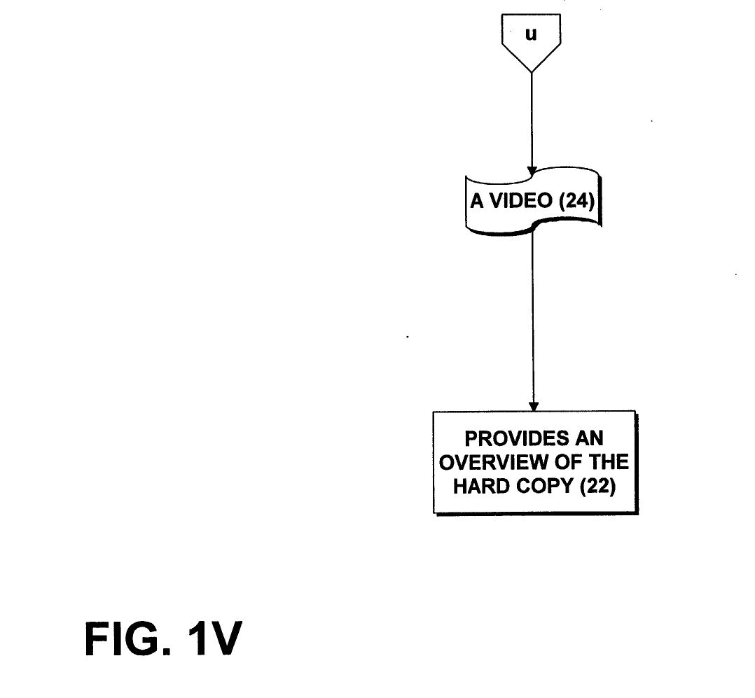

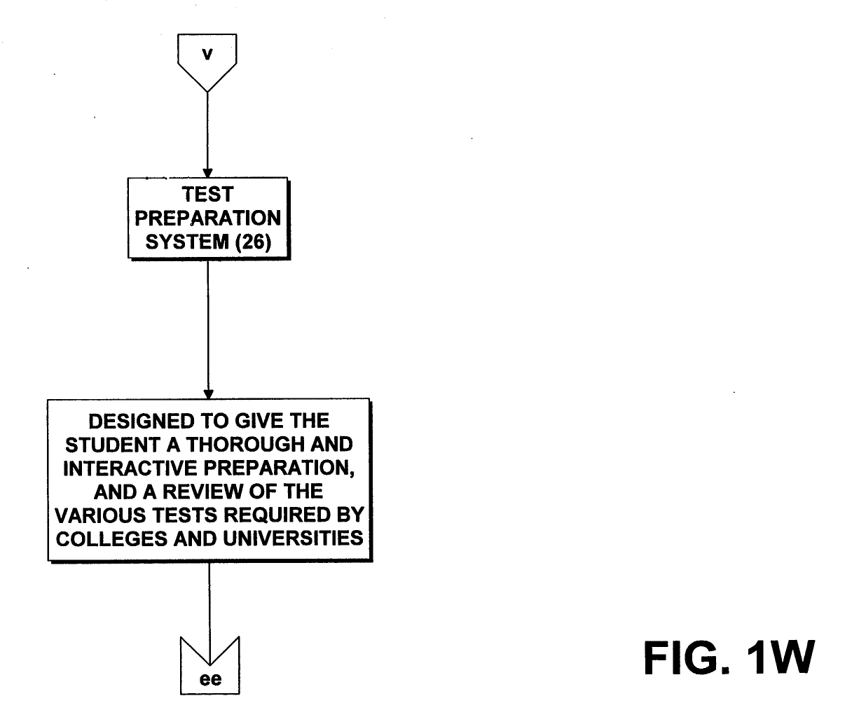

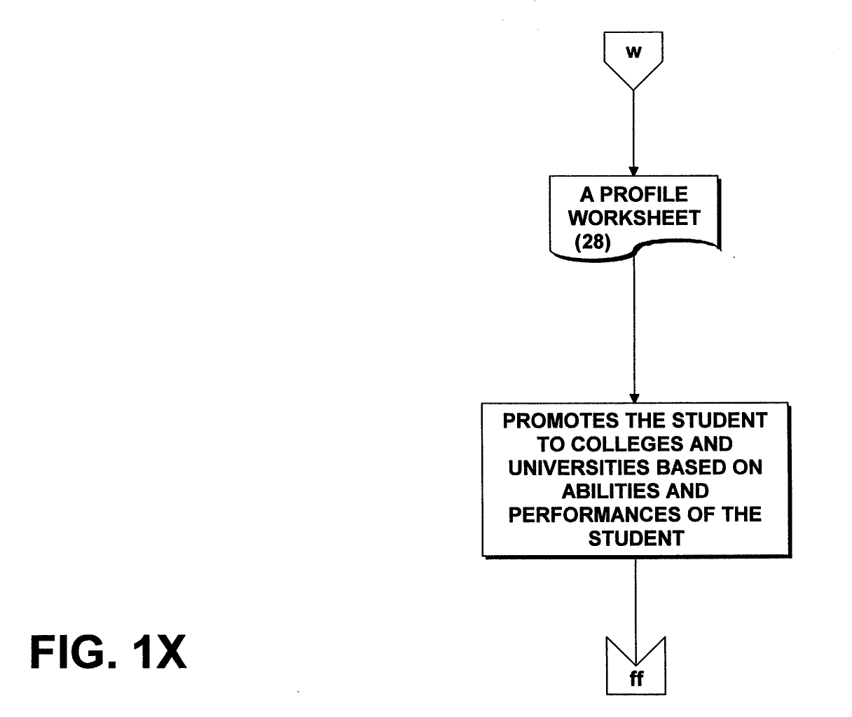

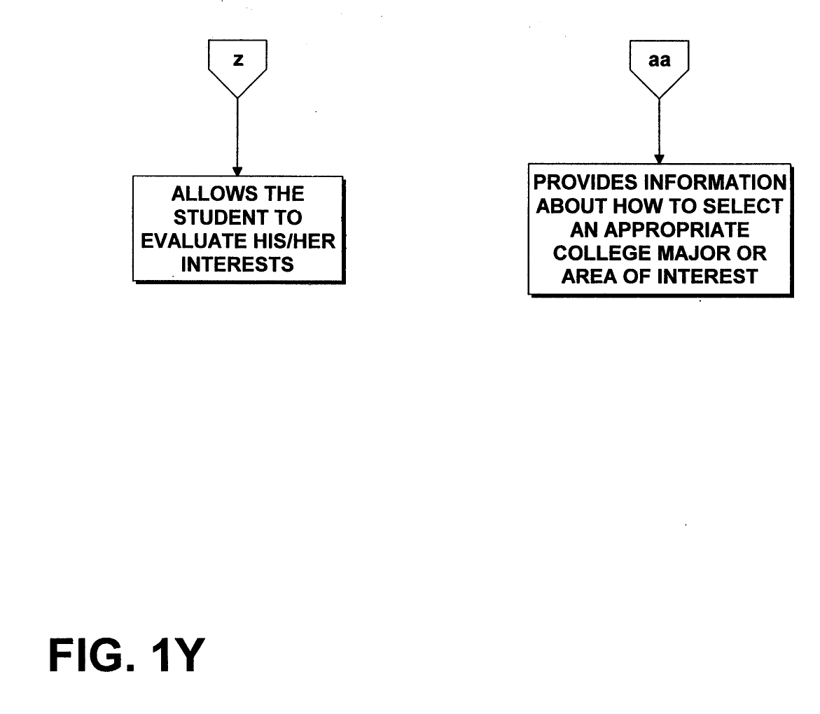

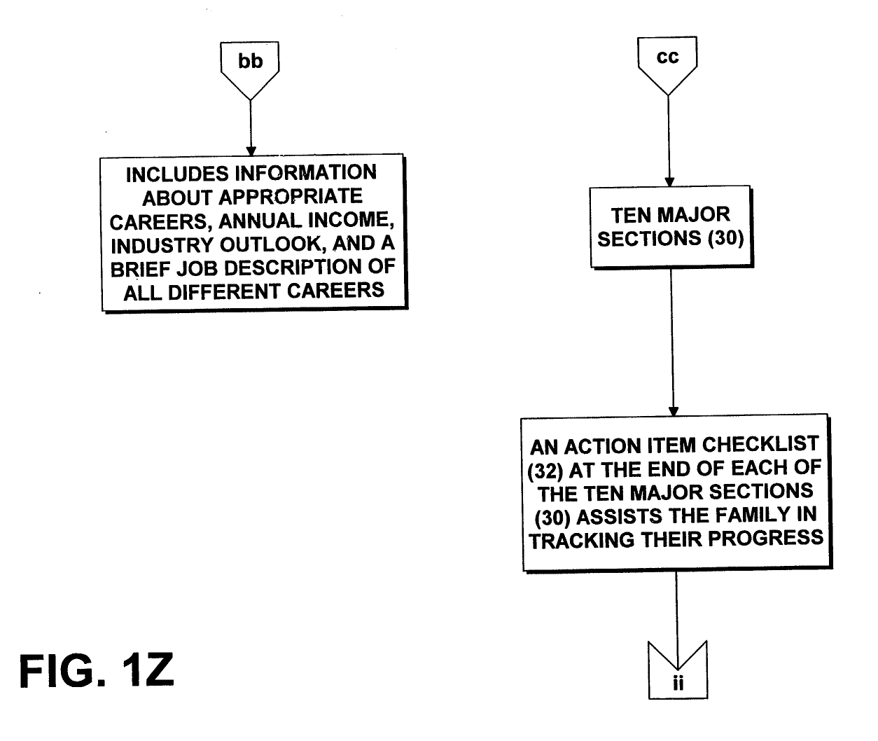

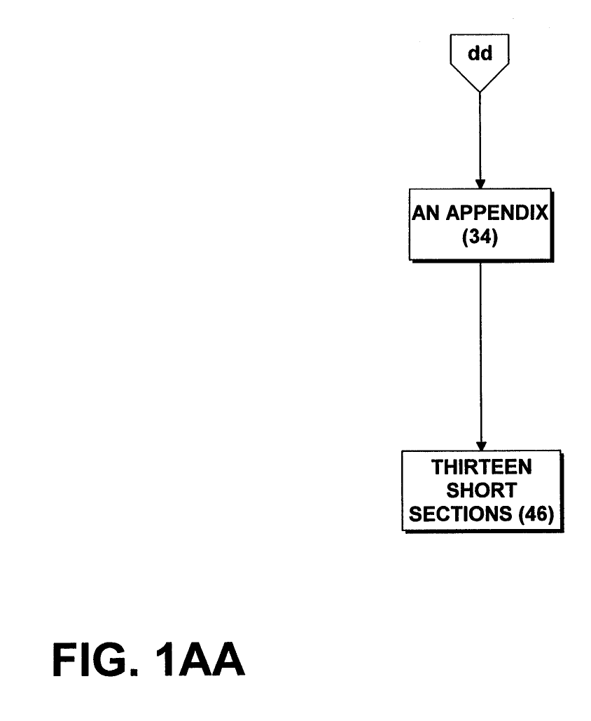

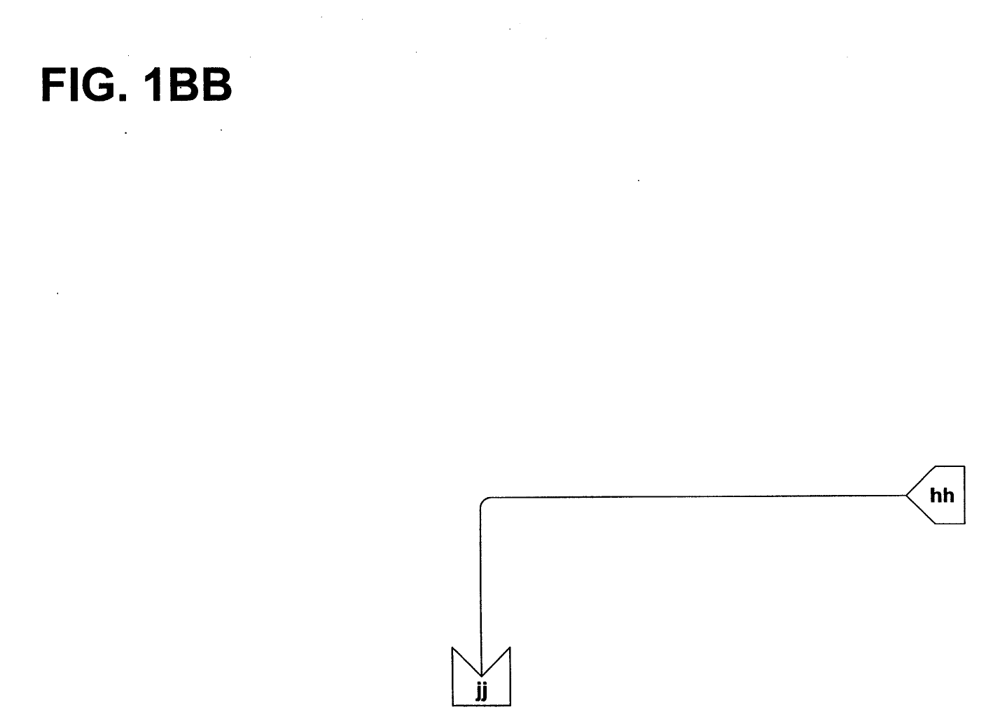

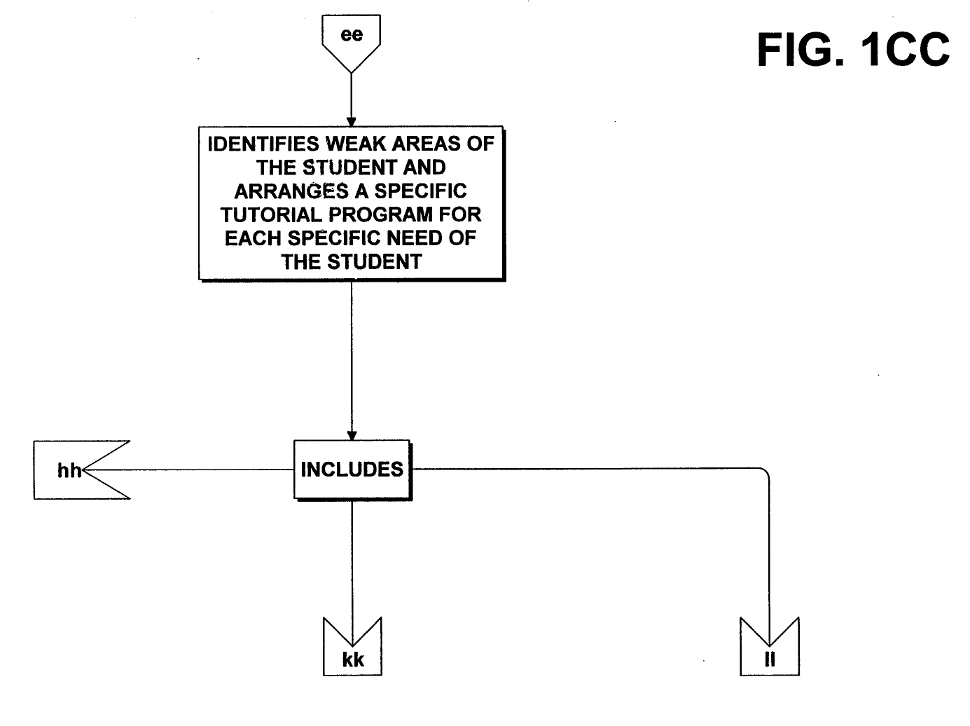

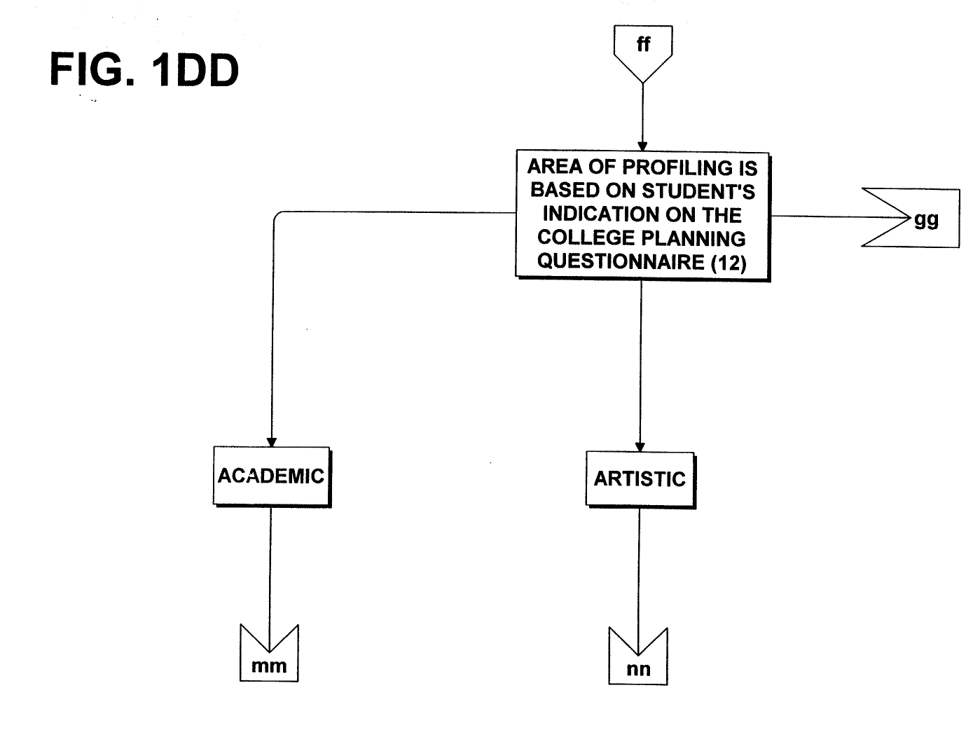

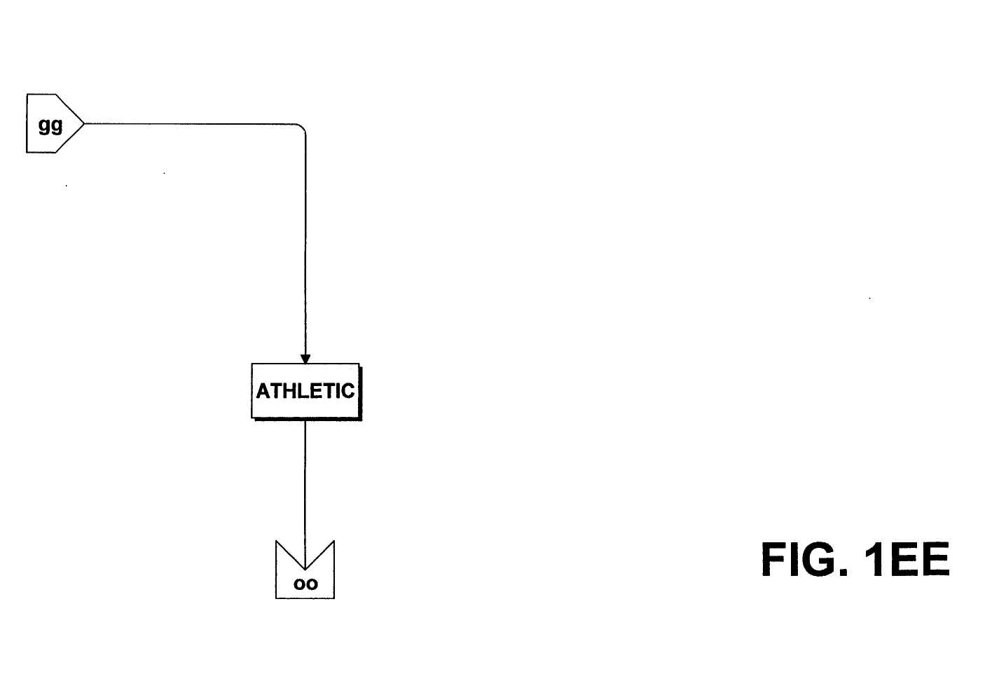

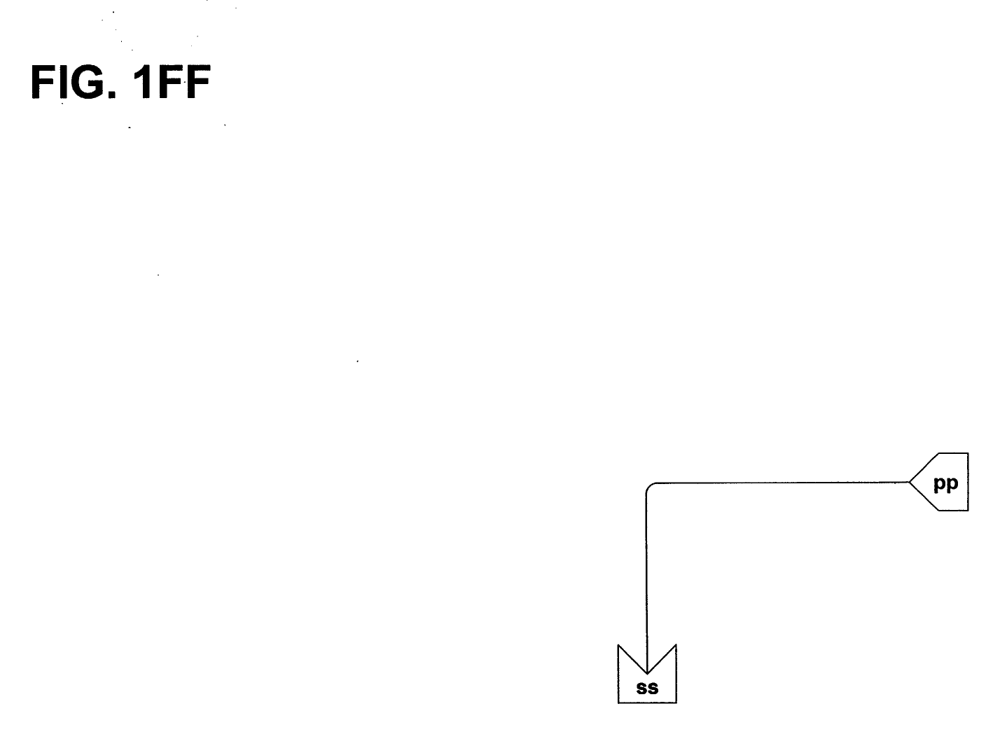

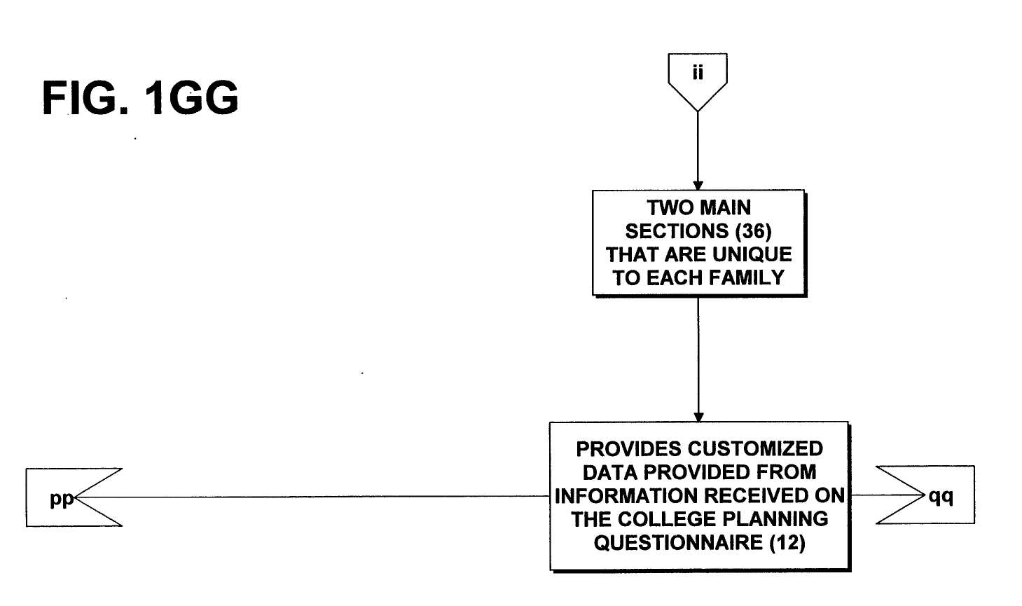

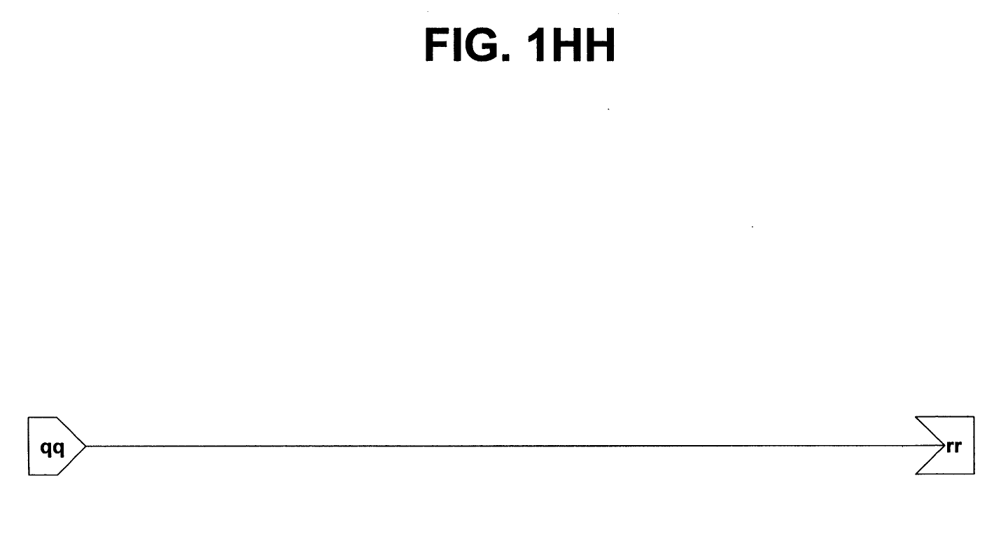

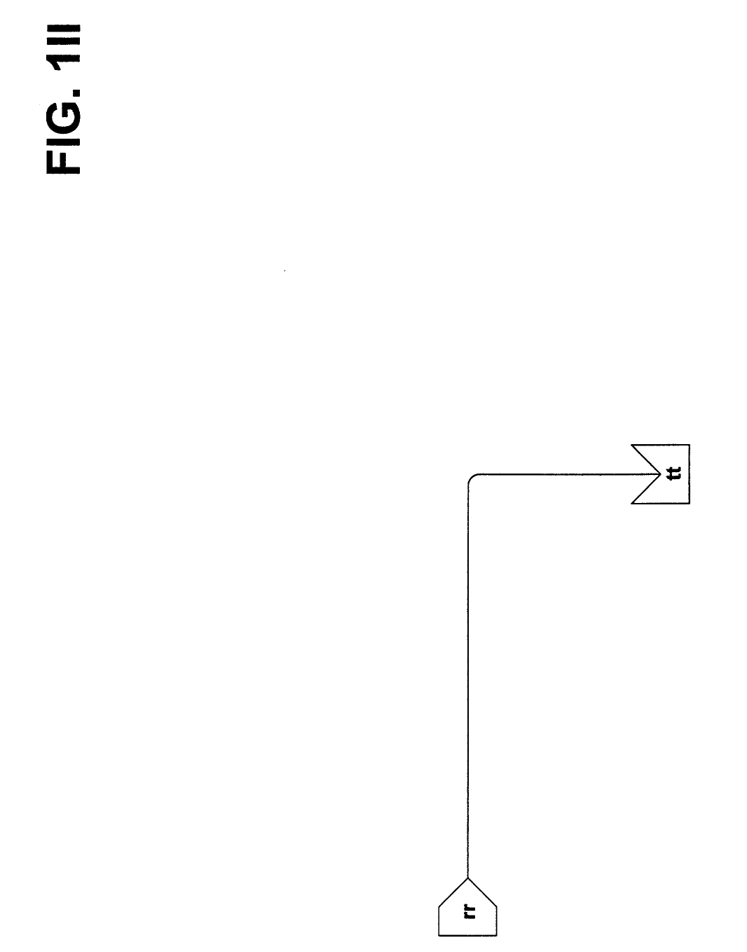

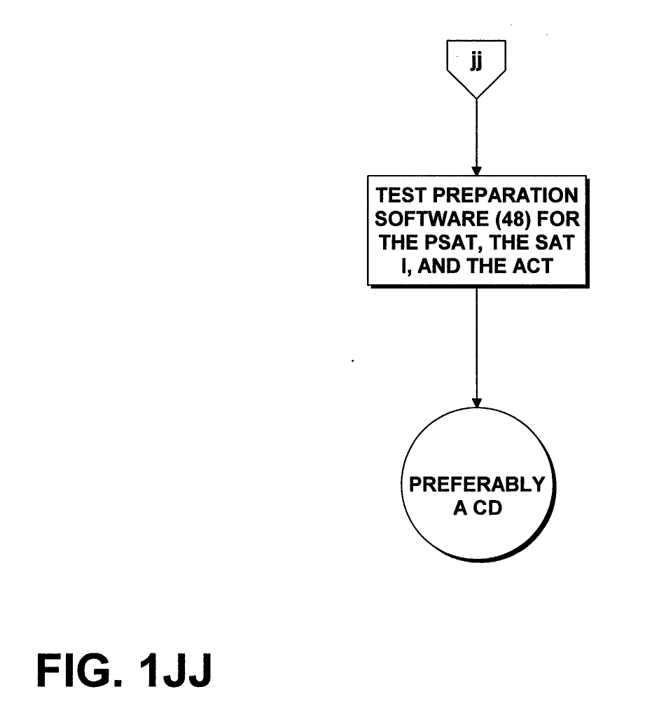

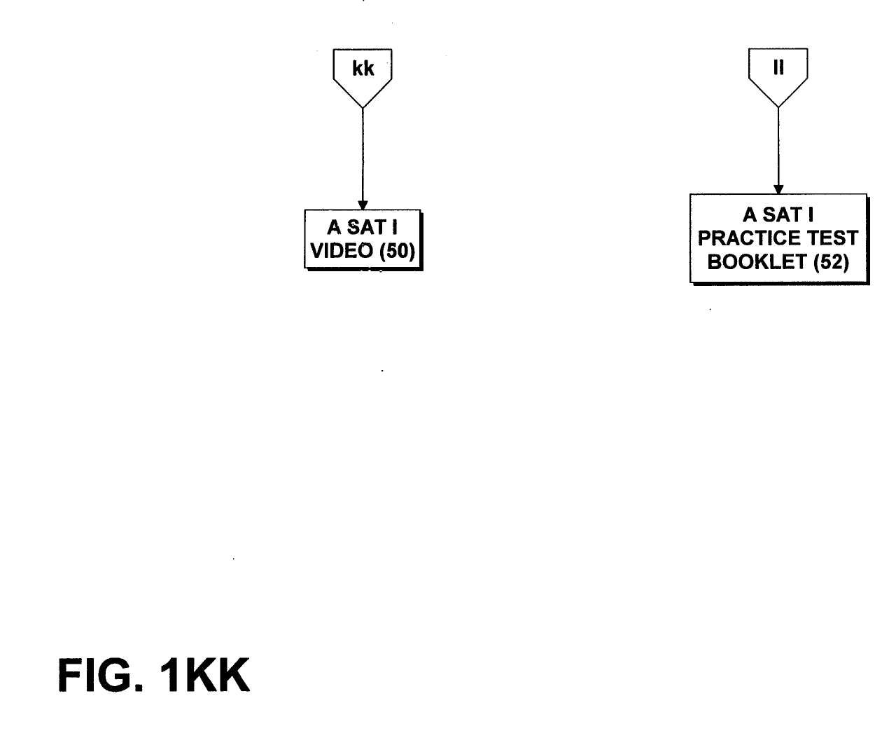

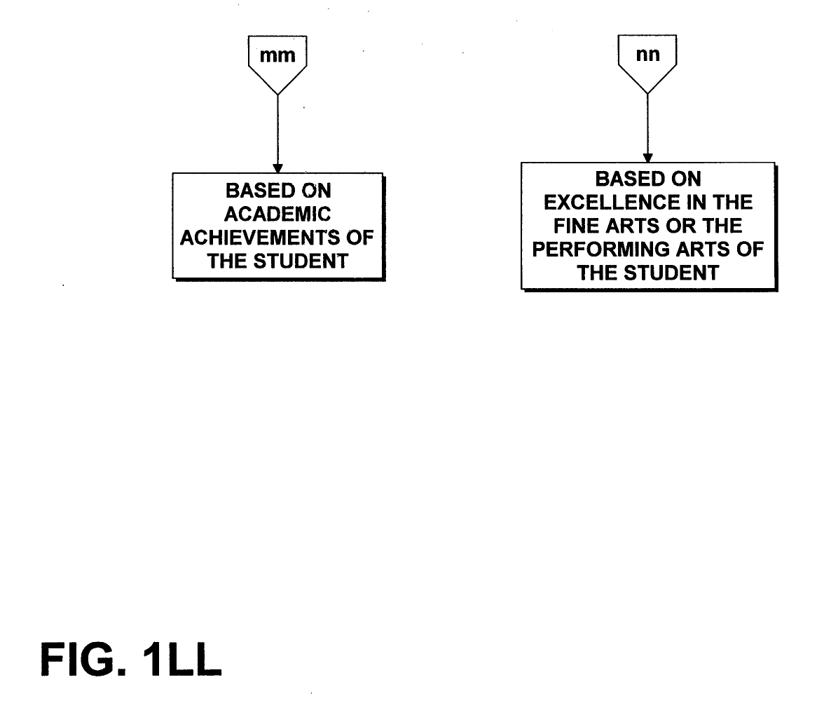

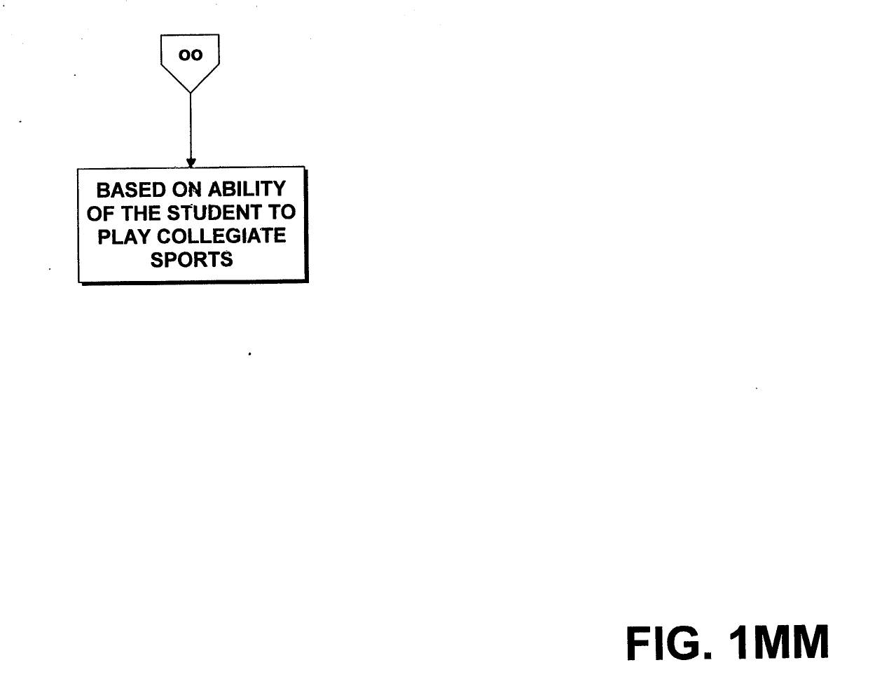

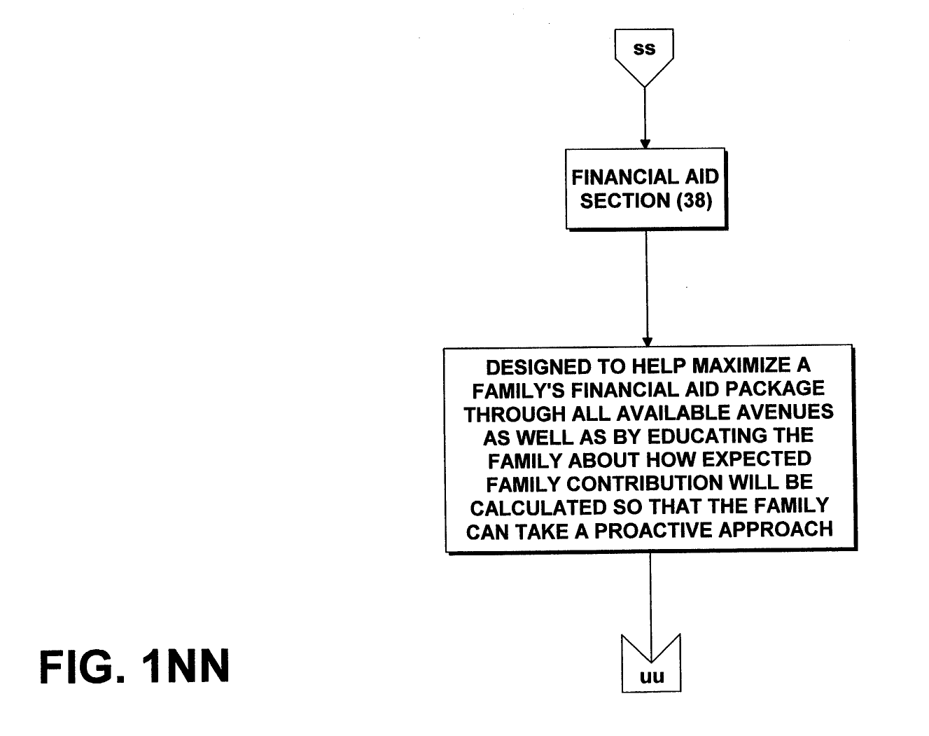

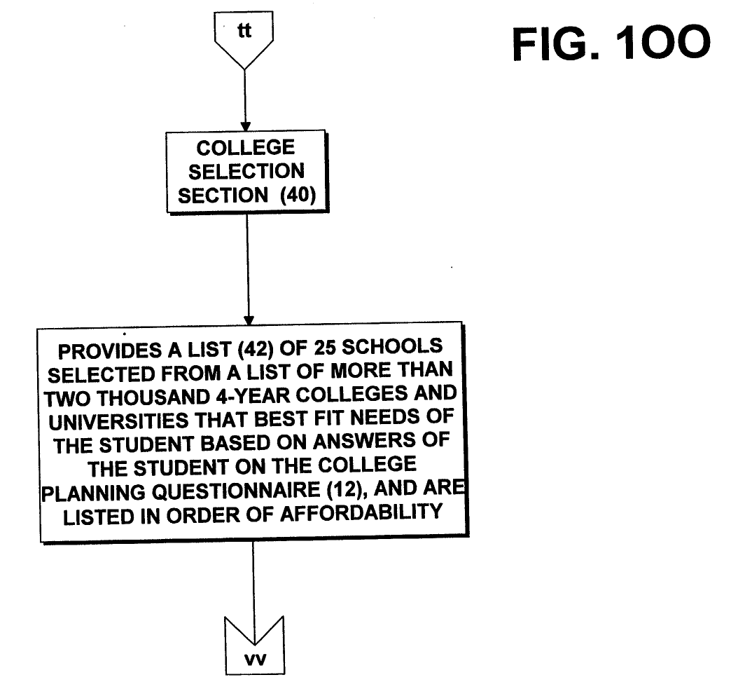

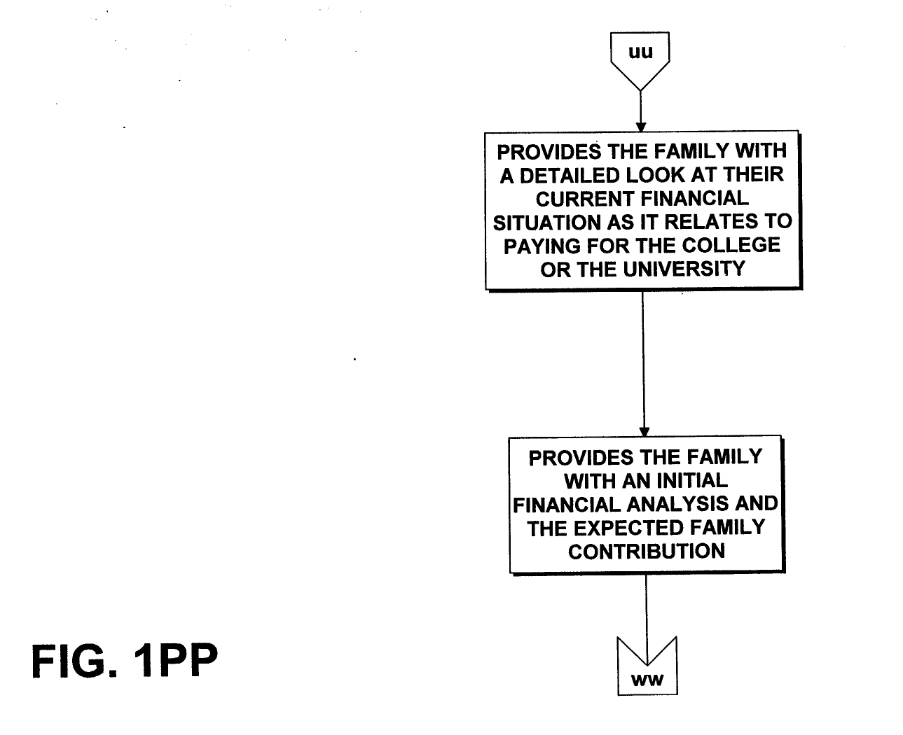

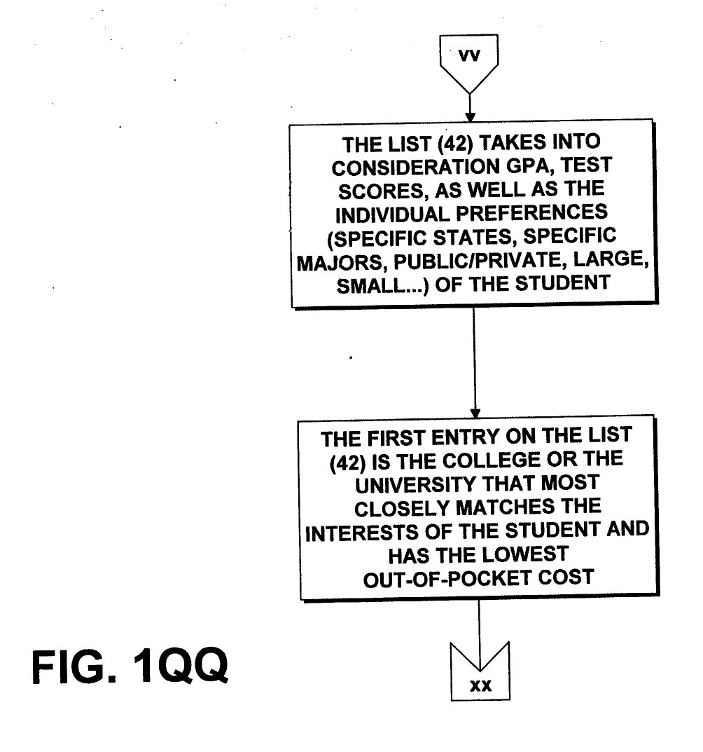

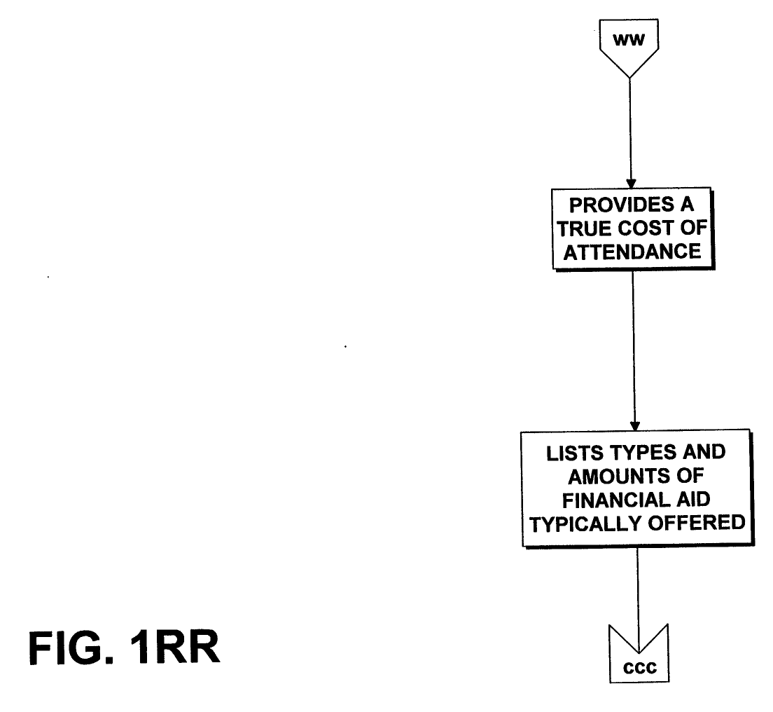

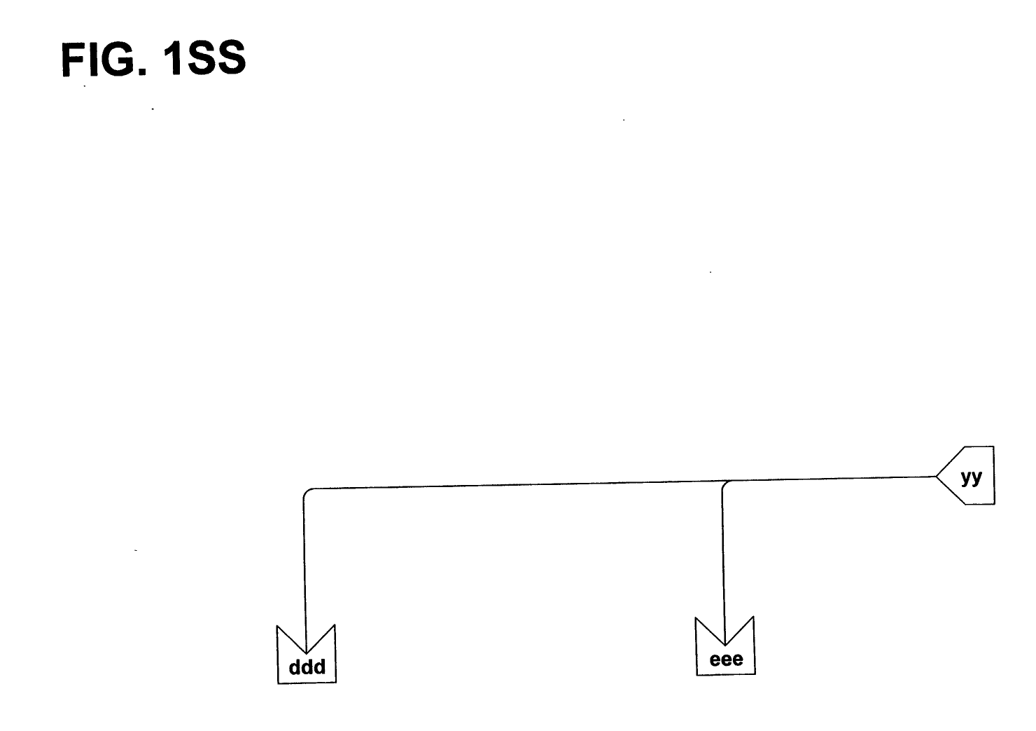

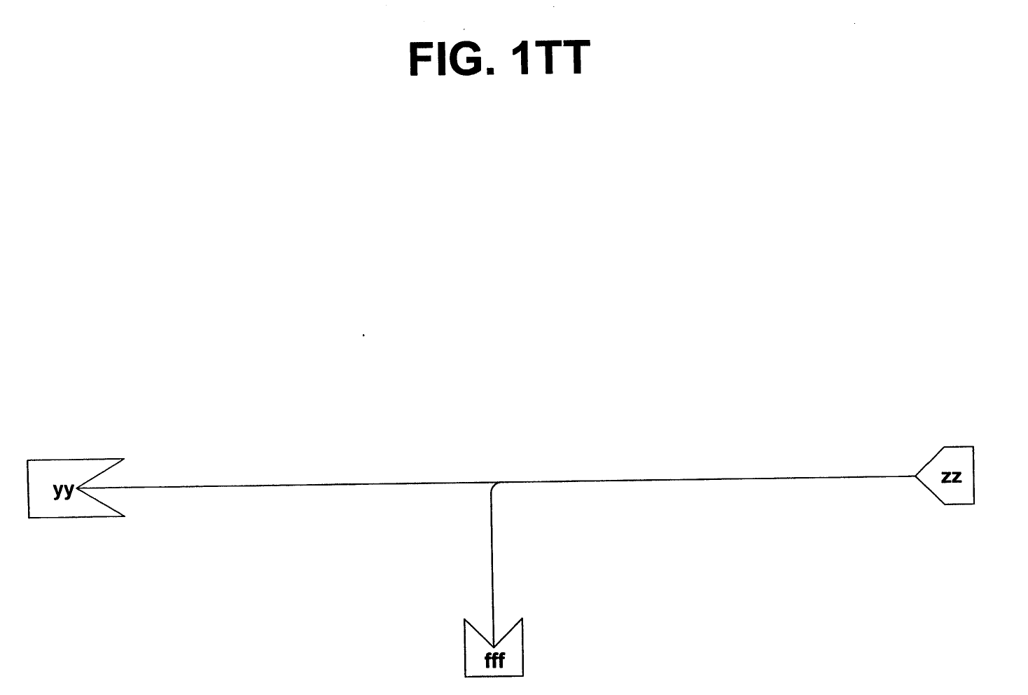

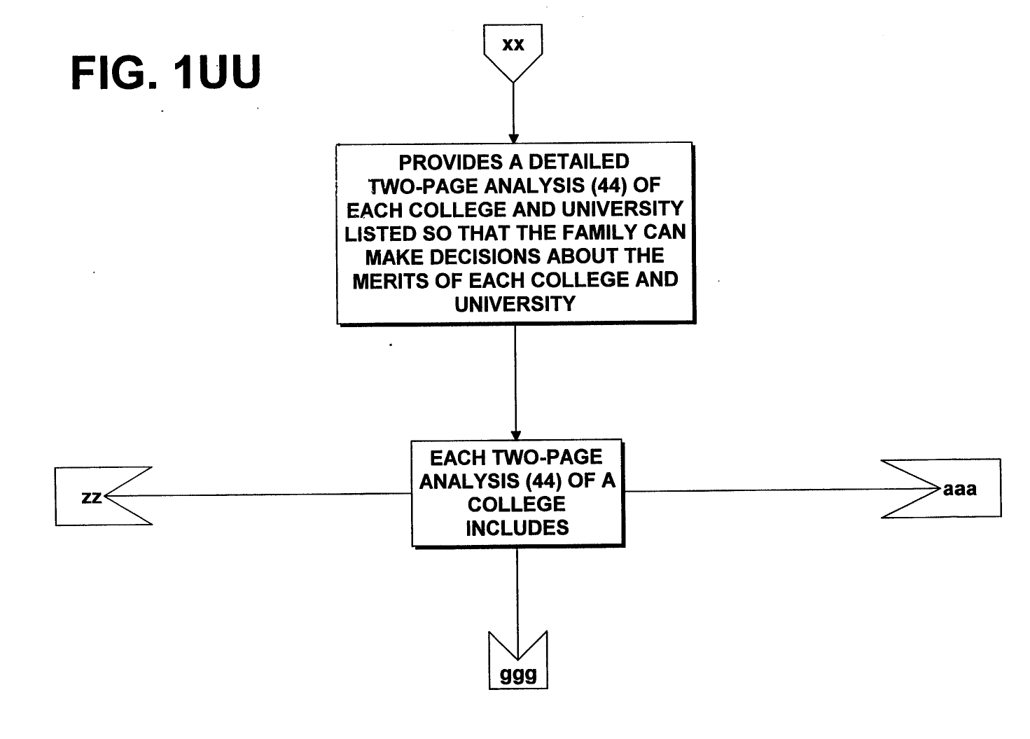

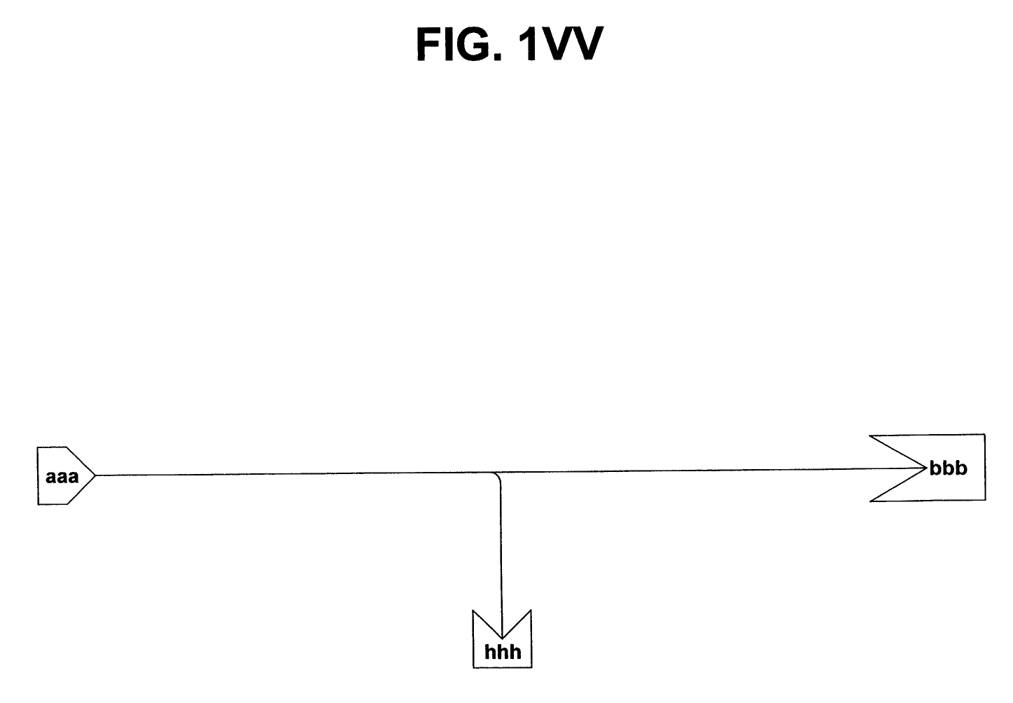

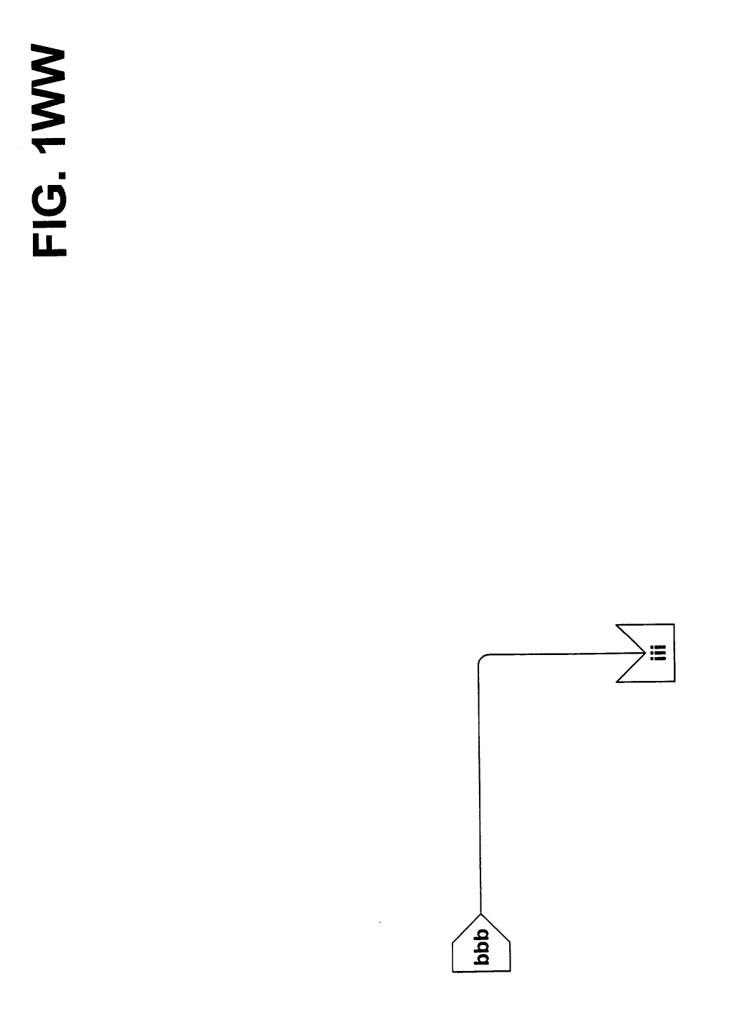

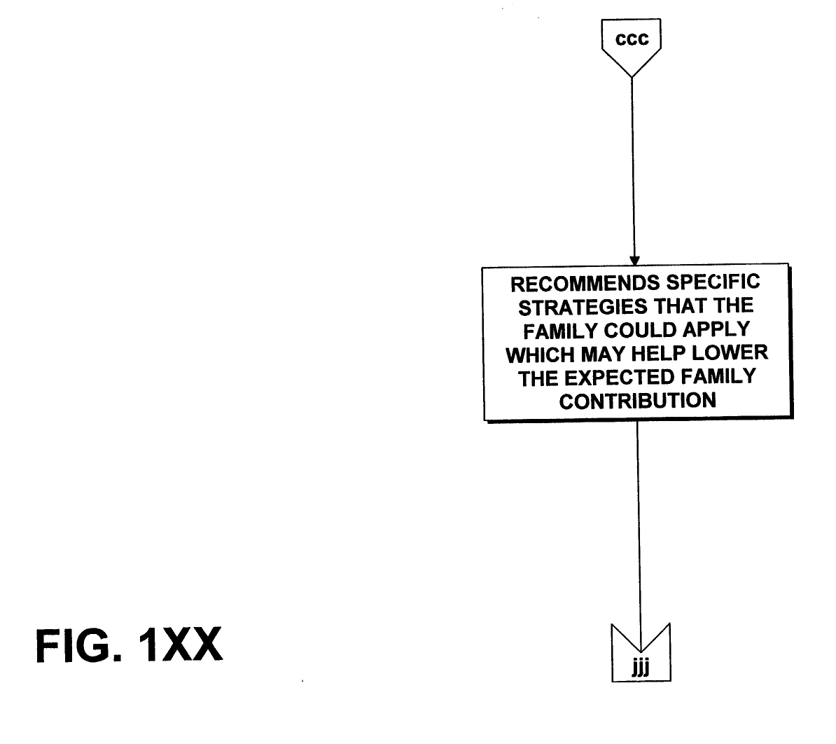

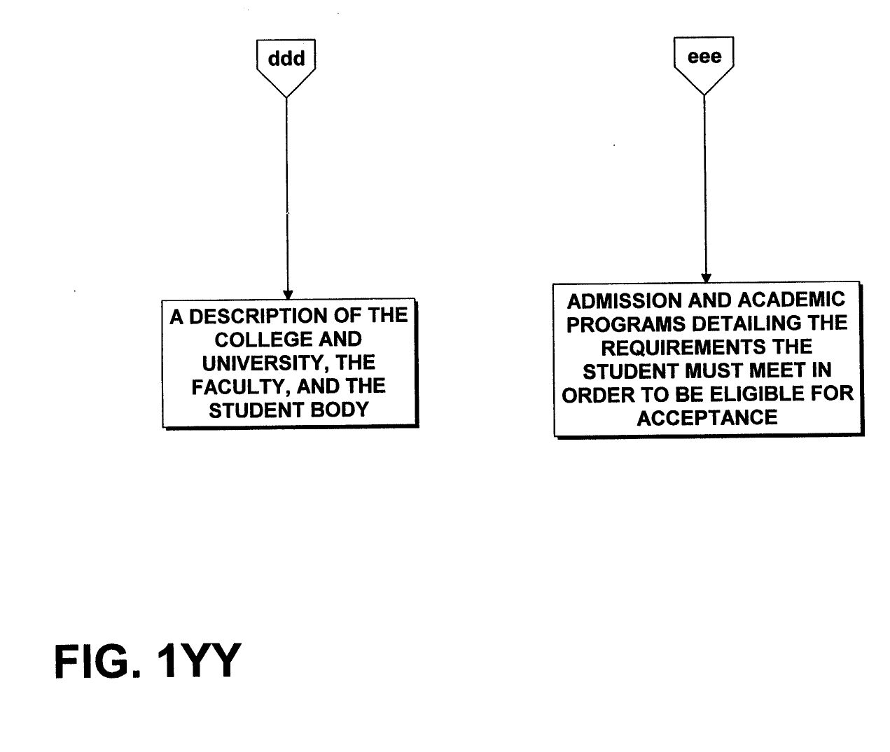

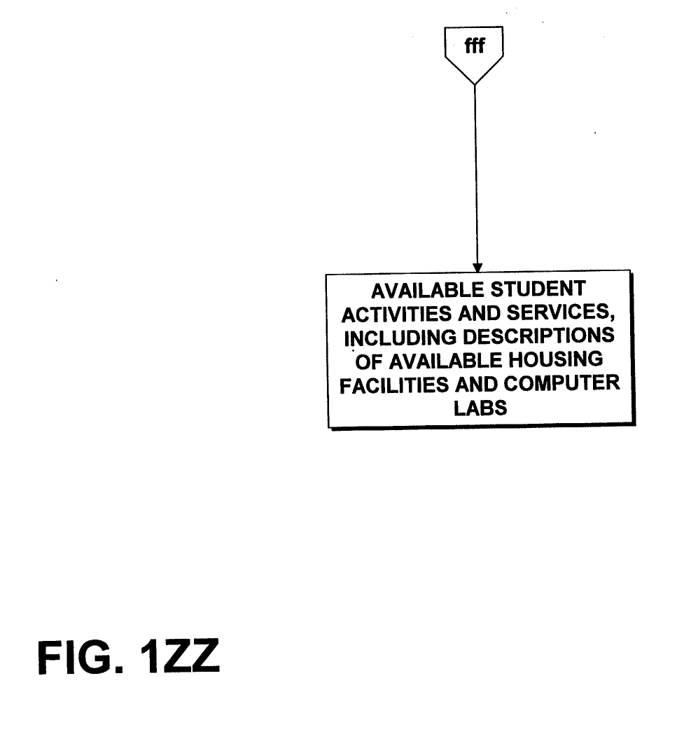

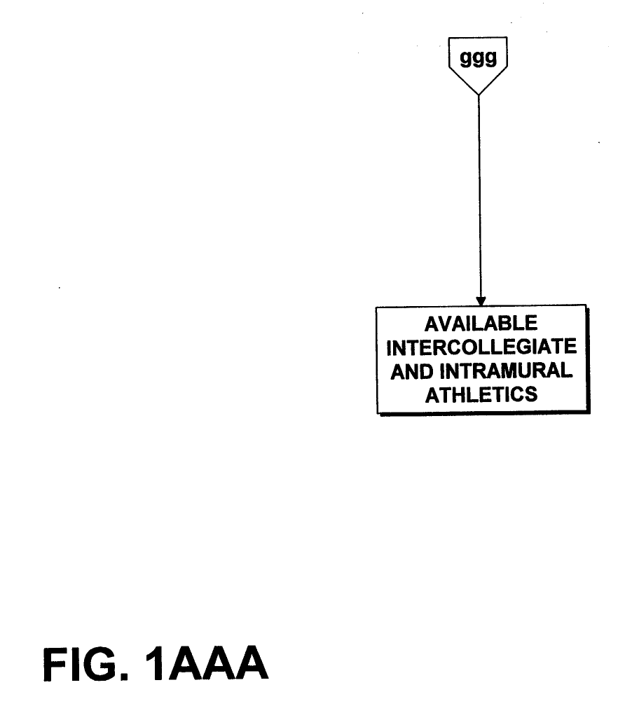

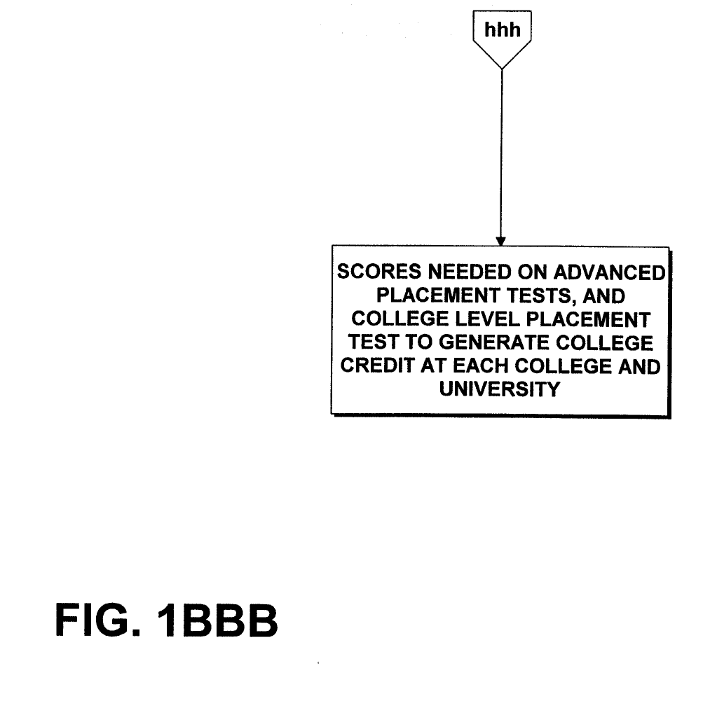

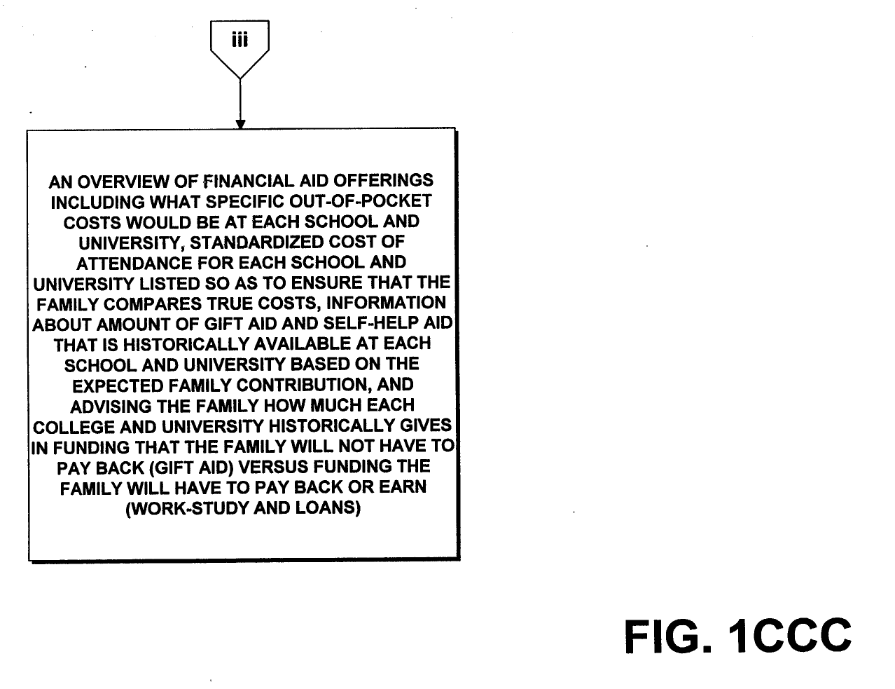

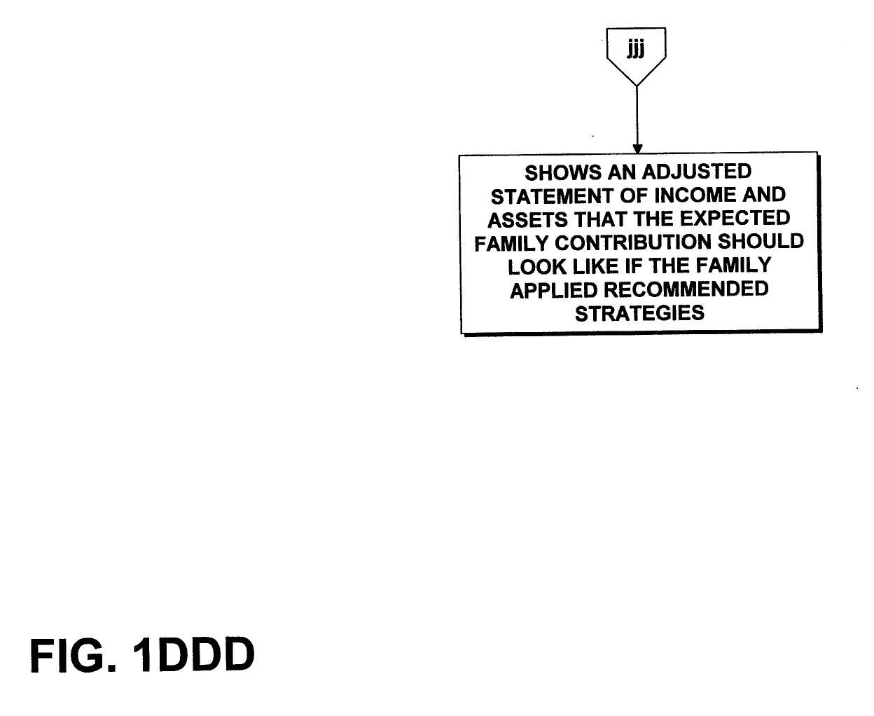

Referring now to the figures, in which like numerals indicate like parts, and particularly to FIGS. 1A-1DDD, which are a system chart of the system for optimizing selection of a college or a university of the present invention, the system of the present invention is shown generally at 10 for optimizing selection of a college or a university for a student with parents forming a family.

The system 10 comprises a college planning questionnaire 12, college planning questionnaire software 14, and a college action plan 16.

The college planning questionnaire 12 collects important data from the family including information about the interests of the student, the aptitude of the student, the abilities of the student, the talents of the student, and the selection preferences of the college or the university of the student, and further collects critical information about the finances of the family from both the parents and the student. The college planning questionnaire 12 is an extensive 12-page document that includes a parents section 18 to be completed by the parents and a student section 20 to be completed by the student.

The college planning questionnaire software 14, preferably a CD, assists the student in filling out the college planning questionnaire 12 by helping the student identify appropriate areas of interest or specific college majors by virtue of the college planning questionnaire software 14 interactively conducting a battery of tests in order to perform a thorough analysis of the likes and dislikes of the student so as to form choices. The college planning questionnaire software 14 compares the choices with corresponding college majors and potential career choices.

A printable report 21 is available after completing each of the battery of tests that allows the student to evaluate his/her interests. The printable report 21 provides information about how to select an appropriate college major or area of interest, and includes information about appropriate careers, annual income, industry outlook, and a brief job description of all different careers.

The college action plan 16 is designed to take the family through the entire college transition process, and is created by information from the college planning questionnaire 12. The college action plan 16 includes only colleges and universities offering degrees in the student's selected major(s), and comprises a hard copy 22, a video 24, a test preparation system 26, and a profile worksheet 28.

The hard copy 22 of the college action plan 16 includes ten major sections 30, with an action item checklist 32 at the end of each of the ten major sections 30 to assist the family in tracking their progress, and an appendix 34. The ten major sections 30 of the hard copy 22 include two main sections 36 that are unique to each family and provide customized data derived from information on the college planning questionnaire 12.

The two main sections 36 of the hard copy 22 include a financial aid section 38 and a college selection section 40. The financial aid section 38 of the hard copy 22 is designed to help maximize a family's financial aid package through all available avenues as well as by educating the family about how expected family contribution will be calculated so that the family can take a proactive approach. The financial aid section 38 provides the family with a detailed look at their current financial situation as it relates to paying for the college or the university, provides the family with an initial financial analysis and the expected family contribution, provides a true cost of attendance, lists the types and the amounts of financial aid typically offered, recommends specific strategies that the family could apply which may help lower the expected family contribution, and shows an adjusted statement of income and assets that the expected family contribution should look like if the family applied the recommended strategies.

The college selection section 40 provides a list 42 of 25 colleges and/or universities selected from a list of more than two thousand 4-year colleges and universities that best fit the needs of the student based on the answers of the student on the college planning questionnaire 12, and are listed in order of affordability. The list 42 takes into consideration the GPA, the test scores, as well as the individual preferences of the student, such as specific states, specific majors, public/private, large, small, etc. The first entry on the list 42 is the college or the university that most closely matches the interests of the student and has the lowest out-of-pocket cost.

The college selection section 40 provides a detailed two-page analysis 44 of each college or university listed so that the family can make decisions about the merits of each college or university. Each two-page analysis 44 of a college or university includes a description of the college or university, the faculty and the student body at the college or university, the admission and academic programs detailing the requirements the student must meet in order to be eligible for acceptance to the college or university, the available student activities and services including descriptions of available housing facilities and computer labs at the college or university, available intercollegiate and intramural athletics at the college or university, the scores needed on advanced placement tests to generate college credit at the college or university, and an overview of the financial aid offerings of the college or university including what specific out-of-pocket costs would there be, a standardized cost of attendance so as to ensure that the family compares true costs, information about the amount of gift aid and self-help aid that is historically available based on the expected family contribution, and how much is historically given in funding that the family will not have to pay back (gift aid) versus funding the family will have to pay back or earn (work-study and loans).

The appendix 34 of the hard copy 22 includes thirteen short sections 46, while the video 24 of the college action plan 16 provides an overview of the hard copy 22 of the college action plan 16.

The test preparation system 26 of the college action plan 16 is designed to give the student thorough and interactive preparation and a review of the various tests required by colleges and universities, and identifies weak areas of the student and arranges a specific tutorial program for each specific need of the student. The test preparation system 26 includes test preparation software 48 for the PSAT, the SAT I, and the ACT, preferably a CD, a SAT I video 50, and a SAT I practice test booklet 52.

The profile worksheet 28 of the college action plan 16 is used to promote the student to colleges and/or universities based on the abilities and performances of the student. The area of profiling is based on the student's indication on the college planning questionnaire 12, and includes academic based on the academic achievements of the student, artistic based on the excellence in the fine arts or the performing arts of the student, and athletic based on the ability of the student to play collegiate sports.

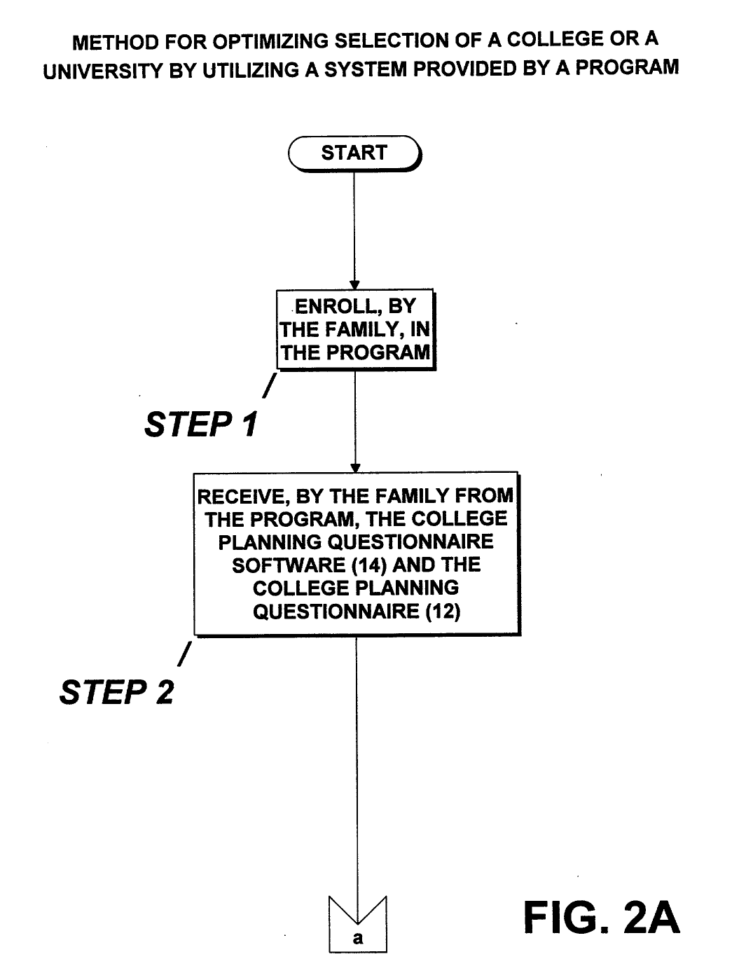

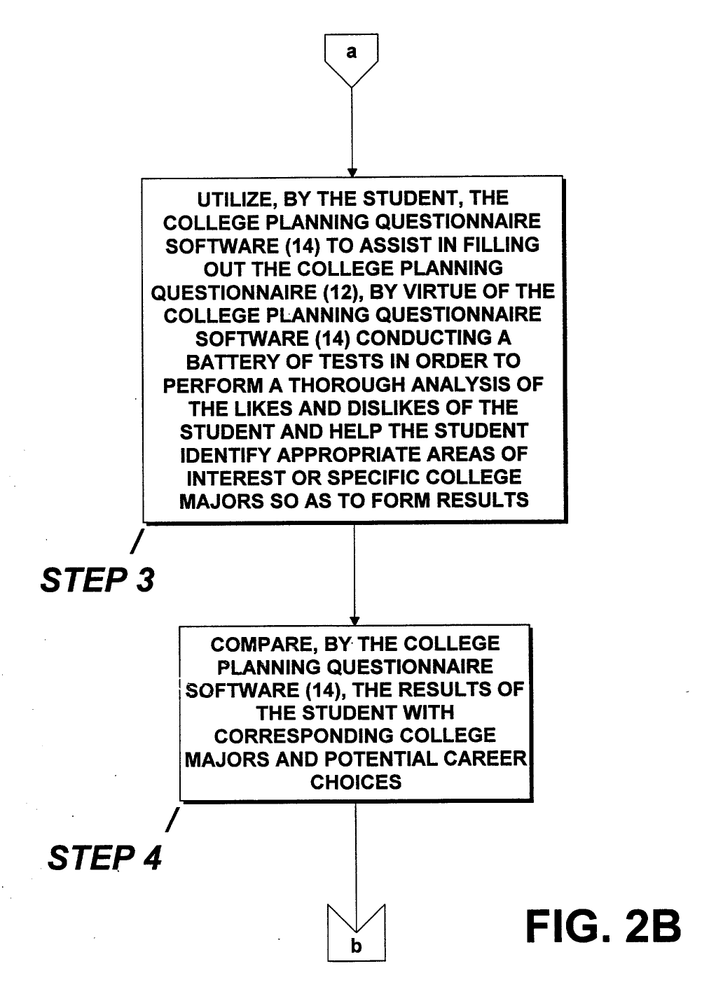

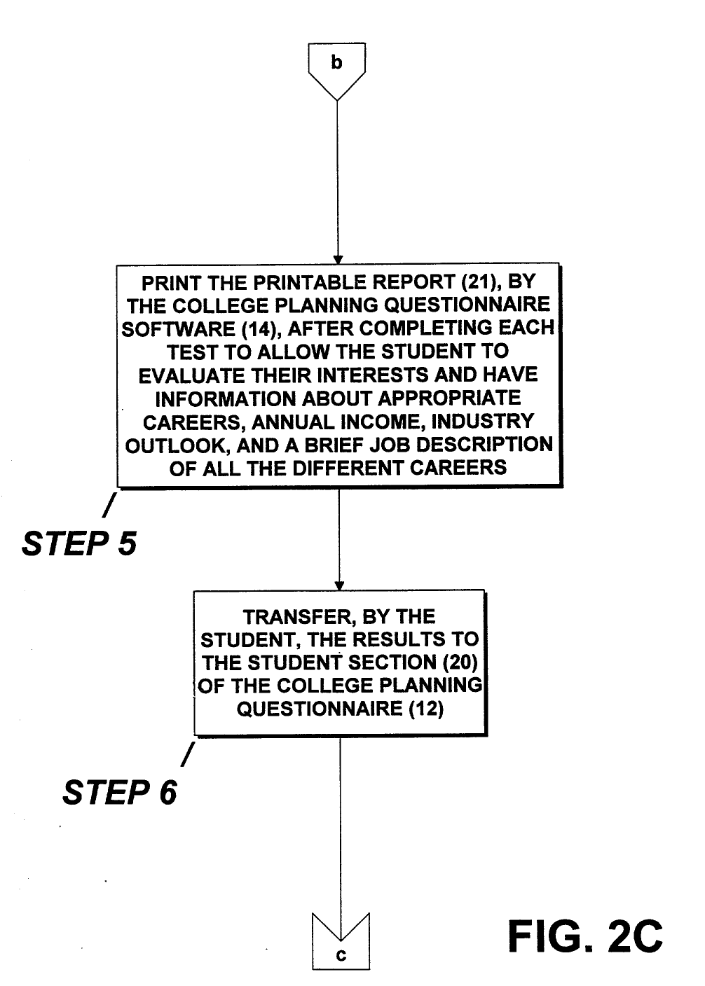

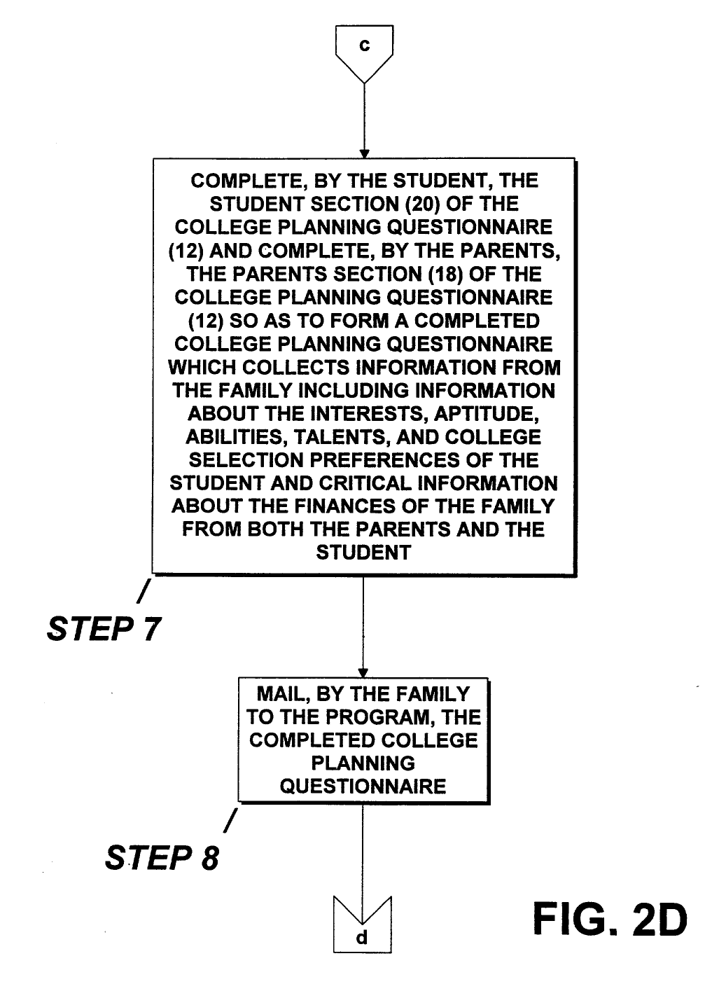

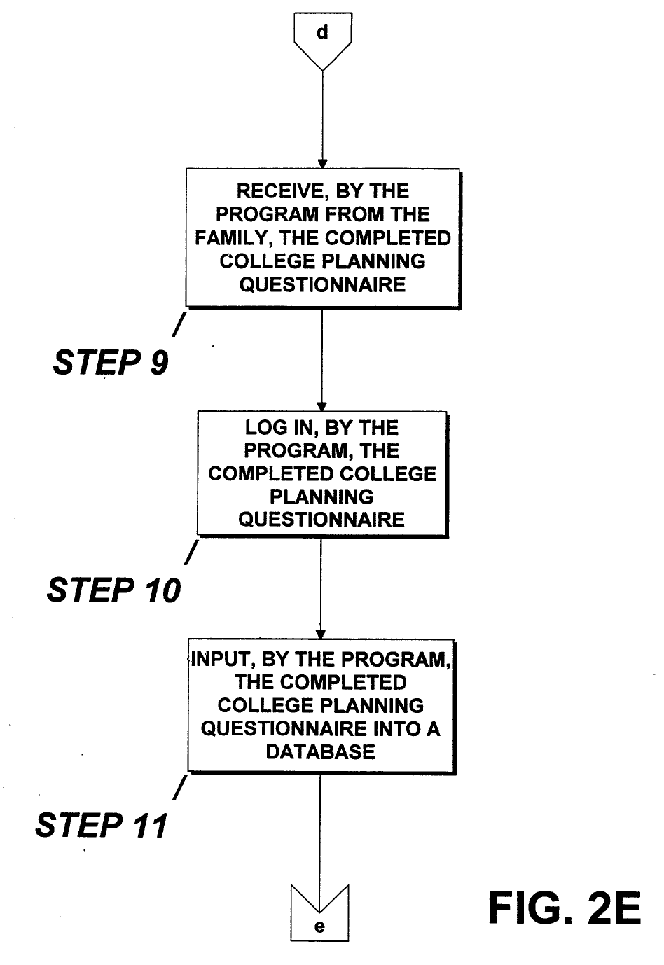

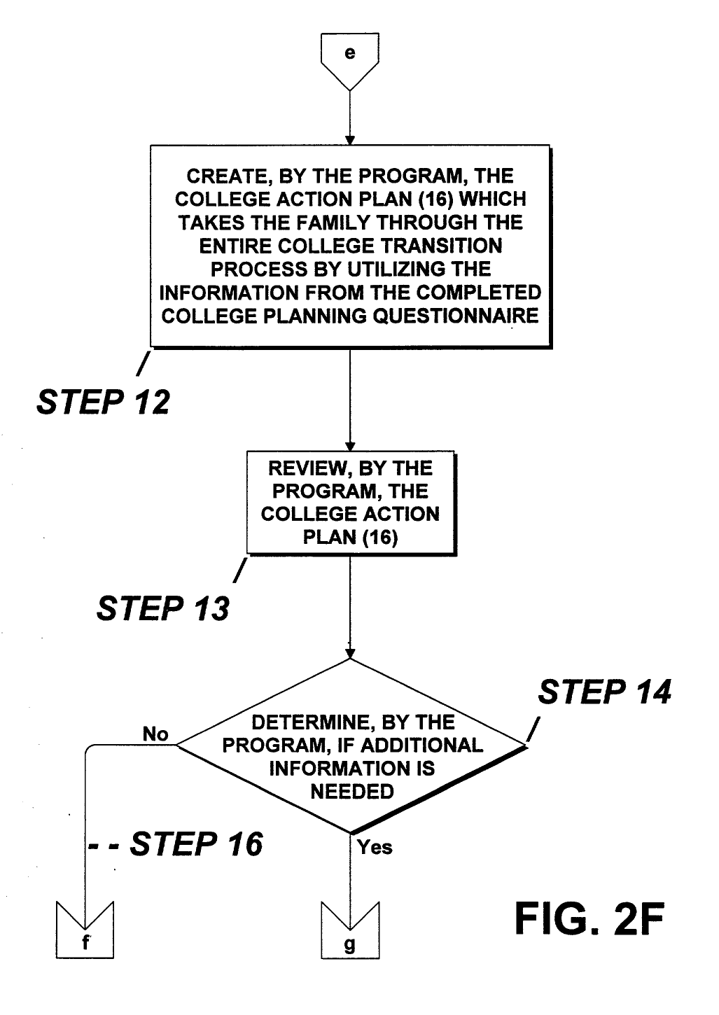

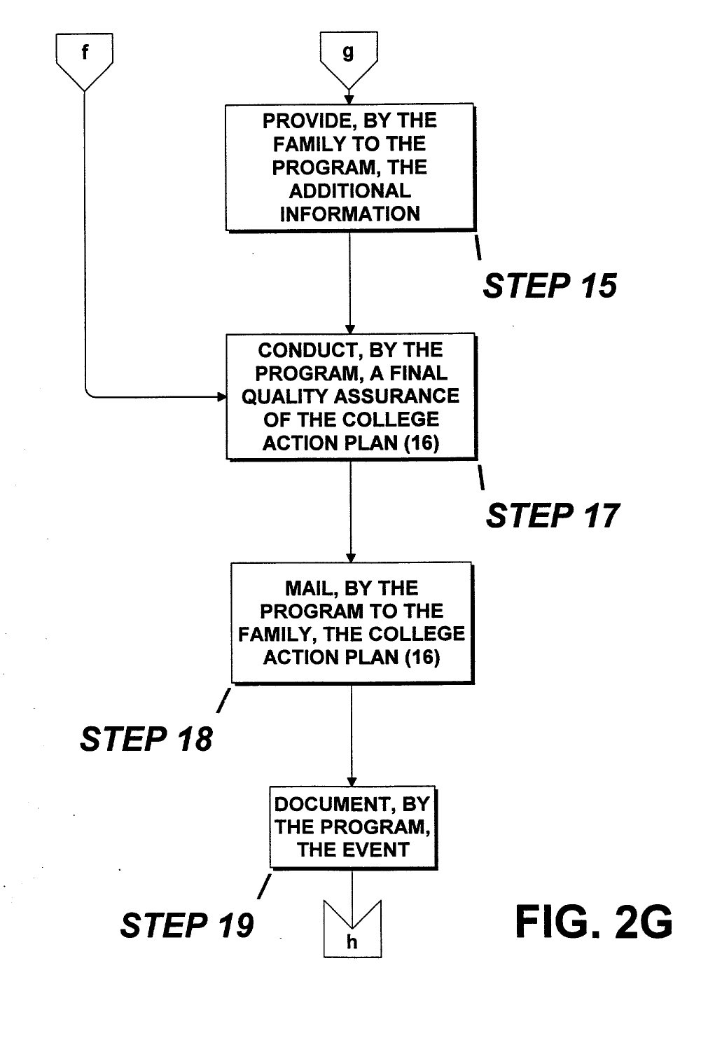

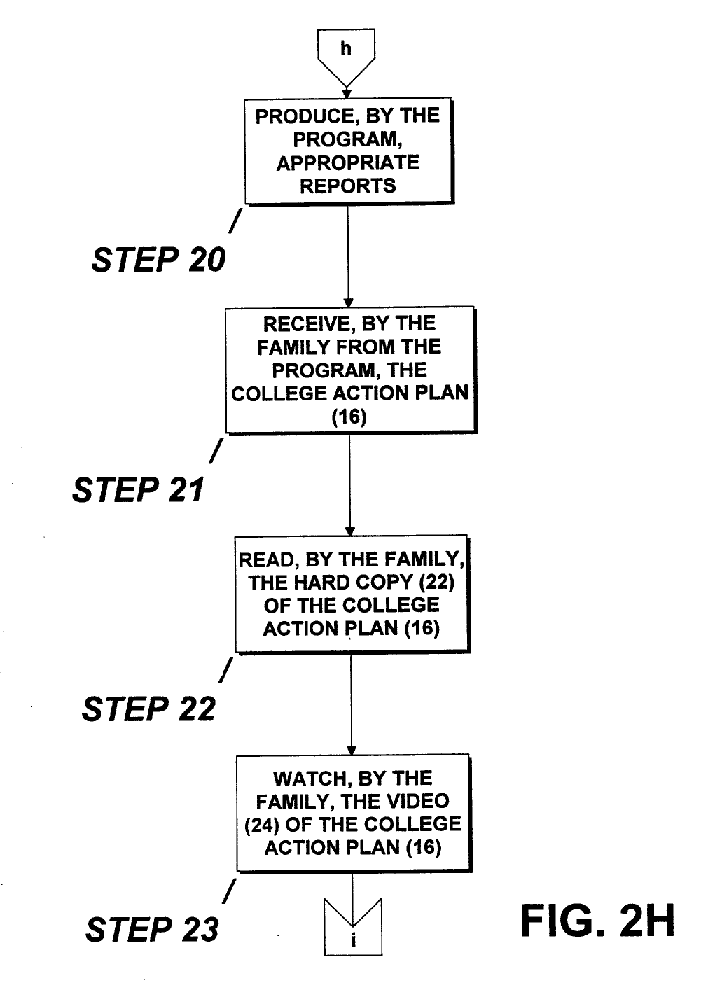

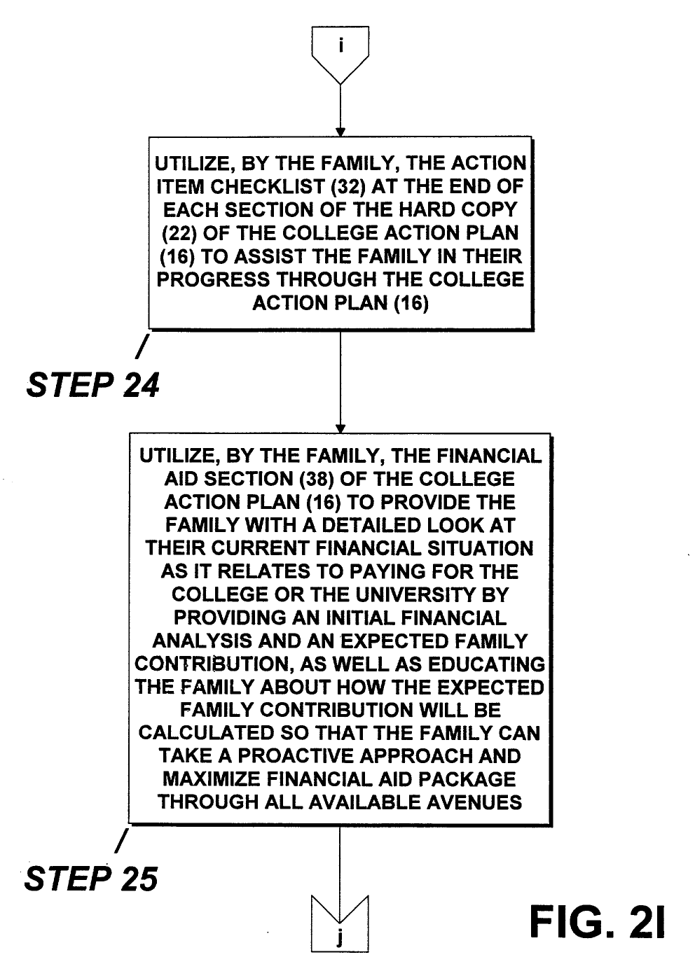

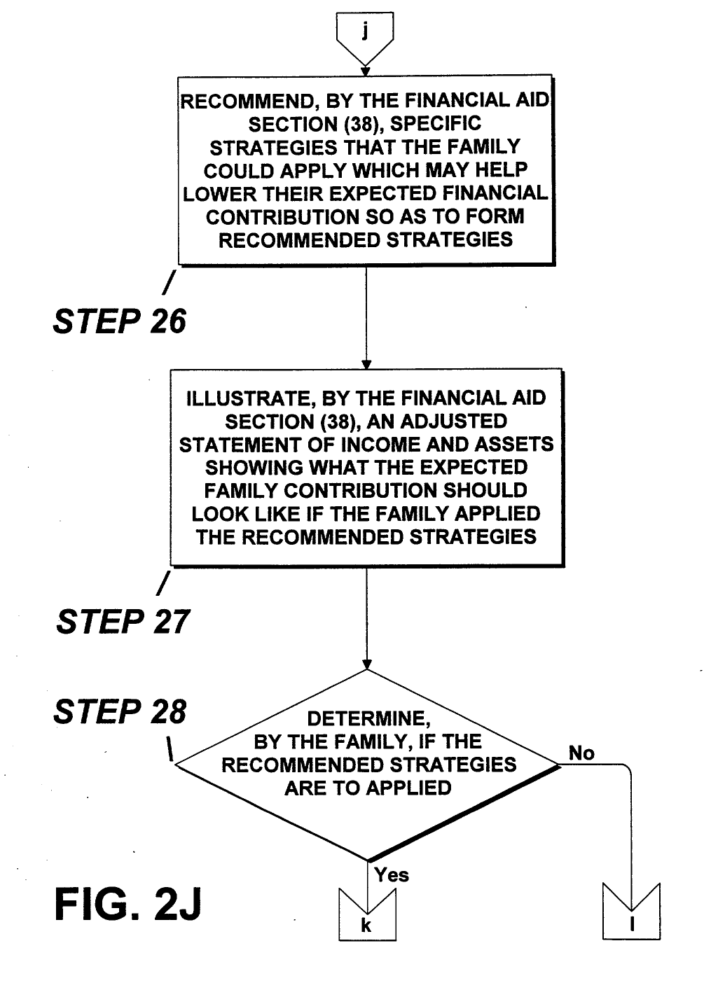

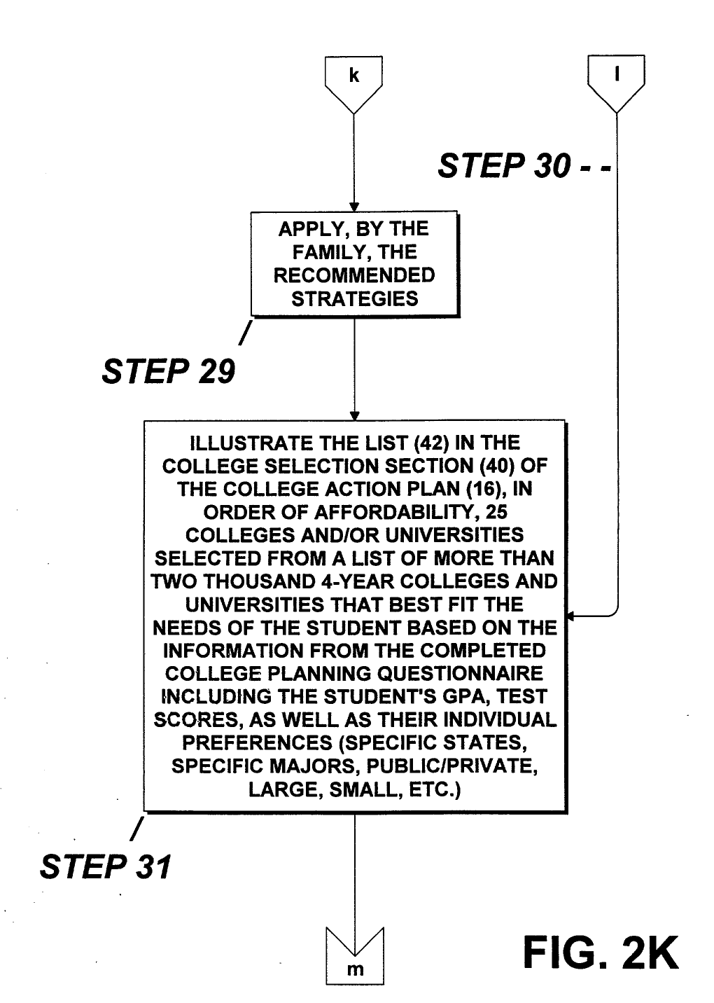

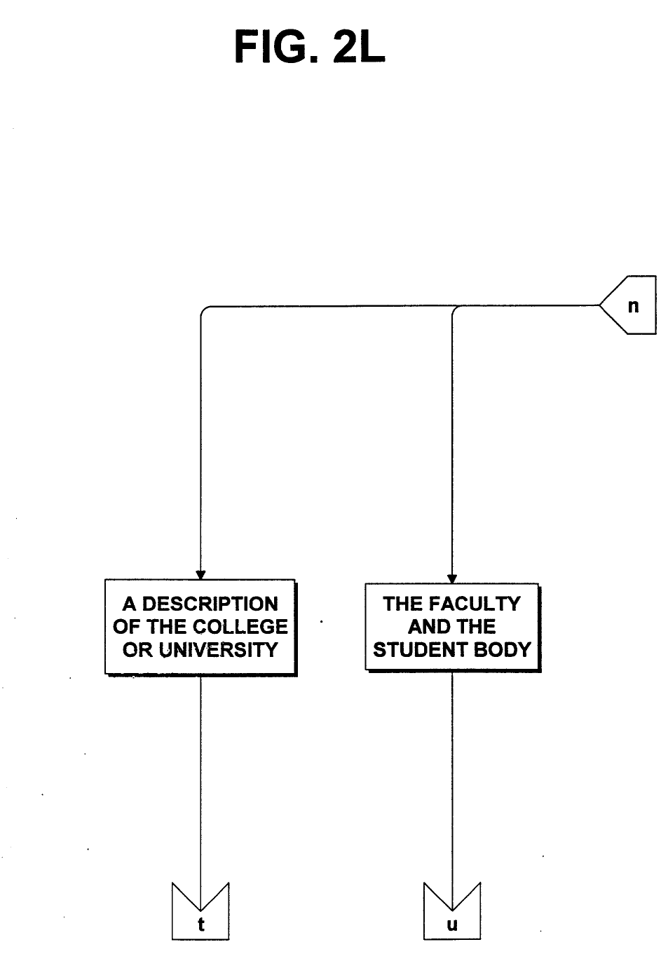

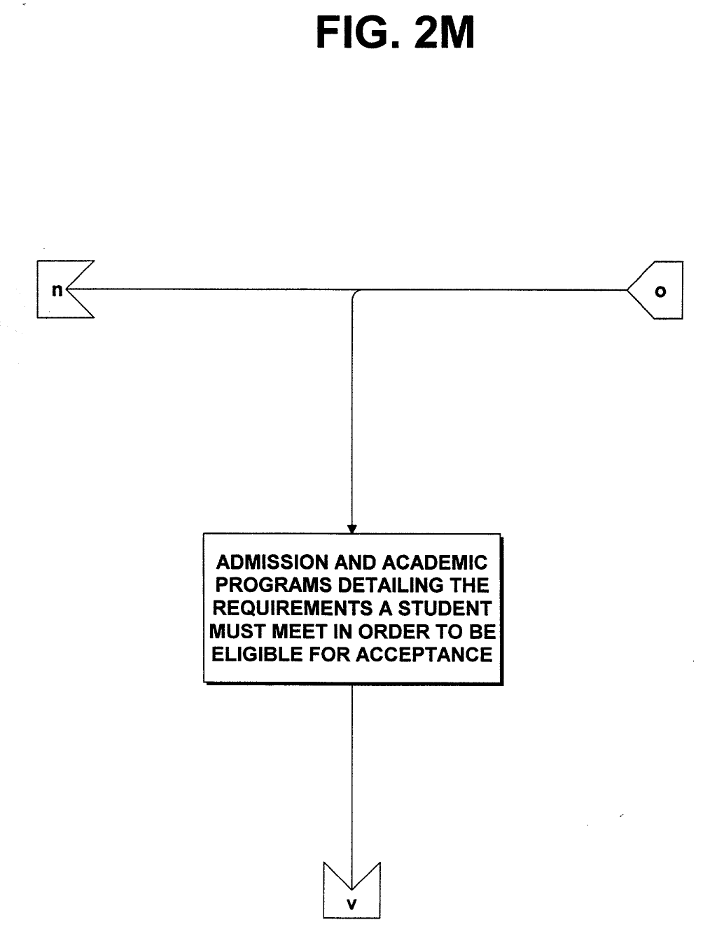

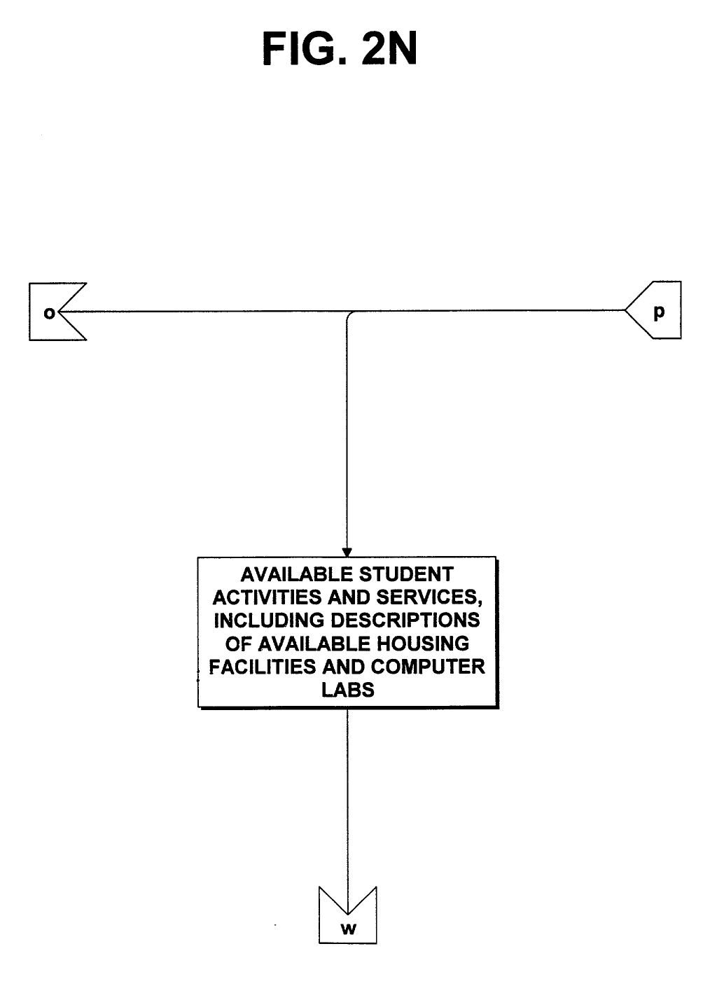

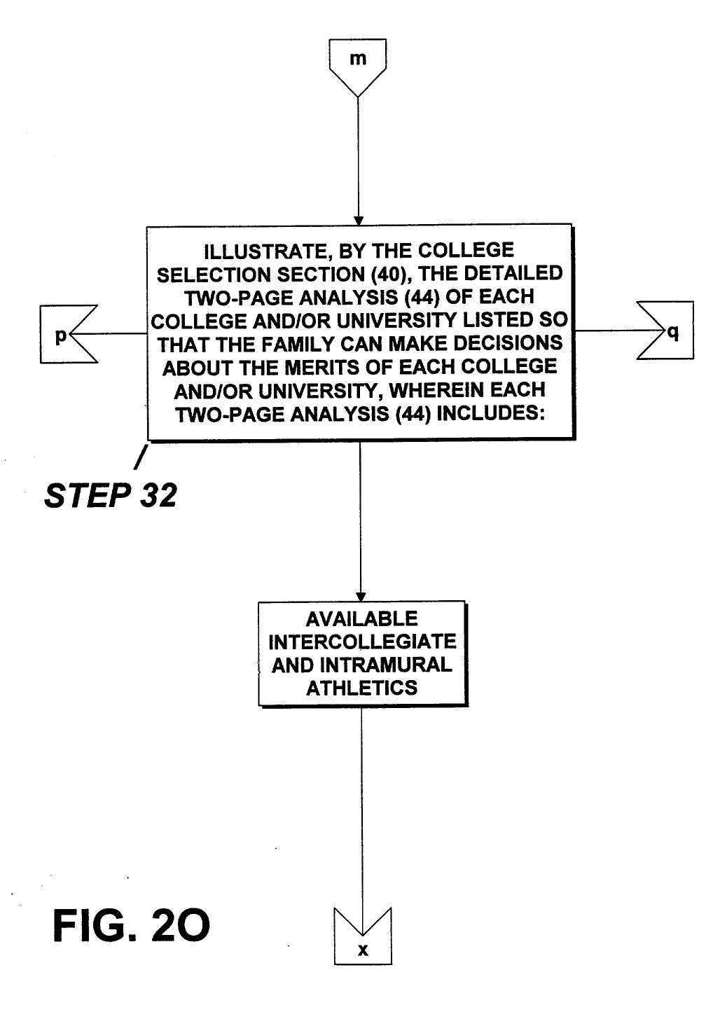

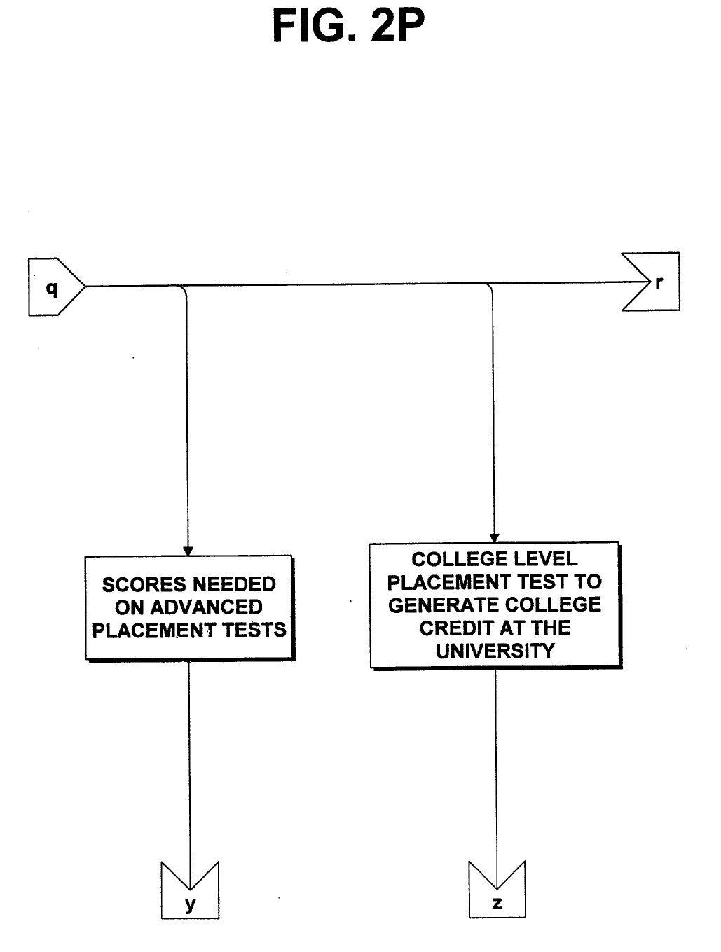

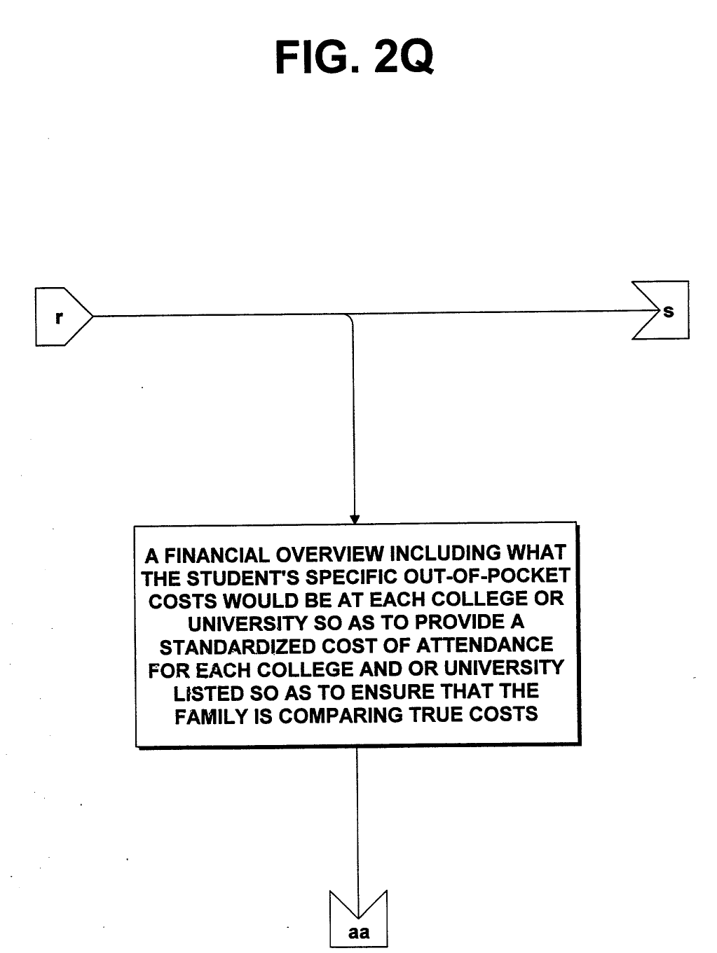

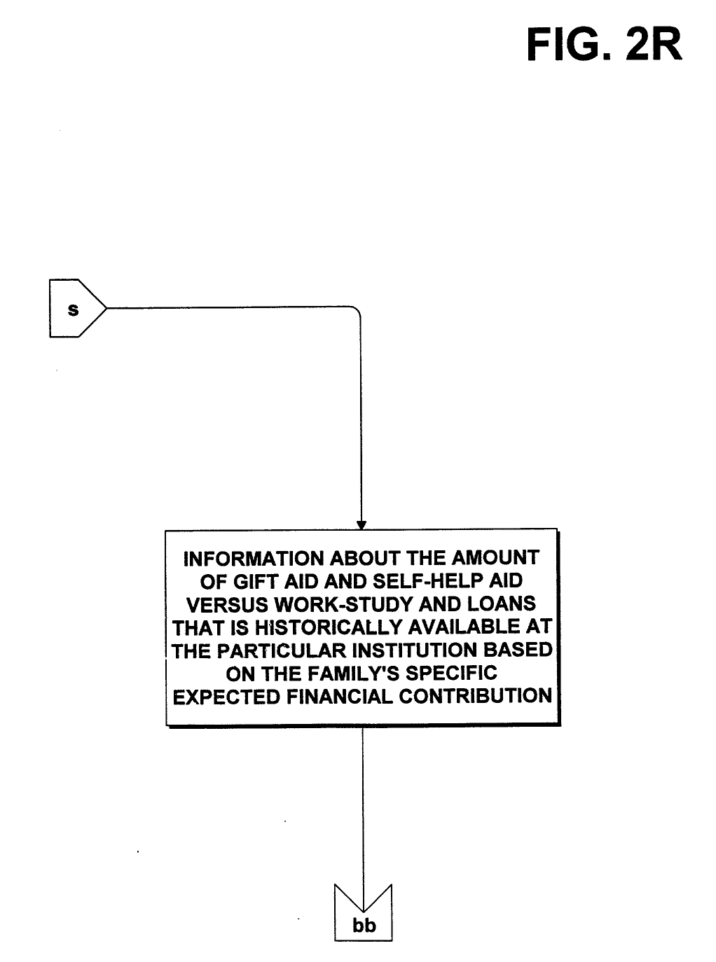

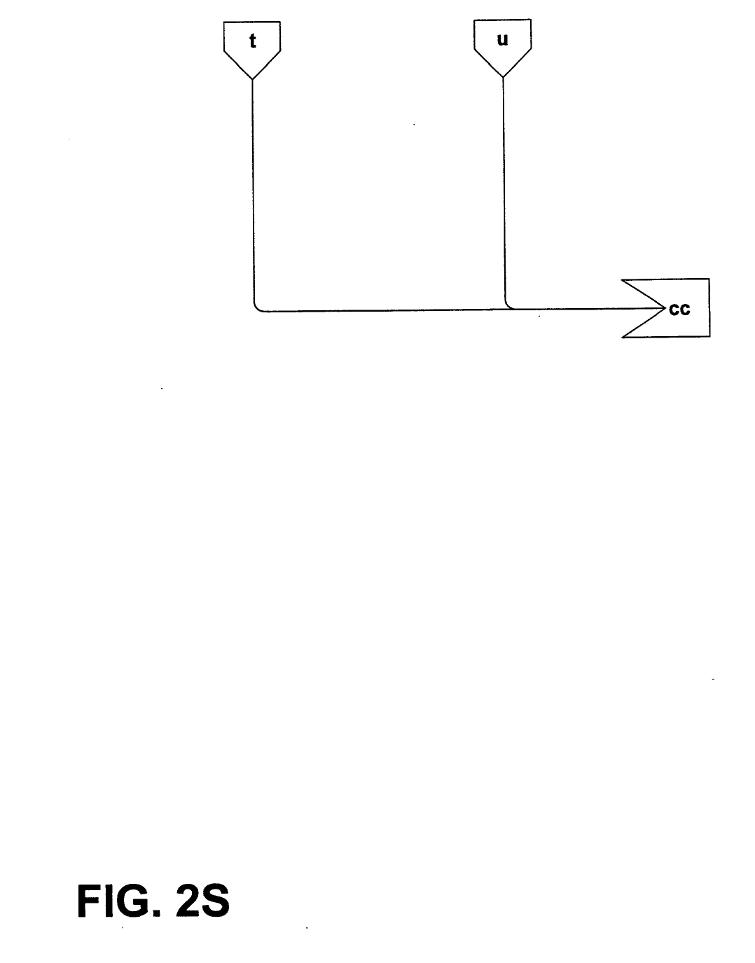

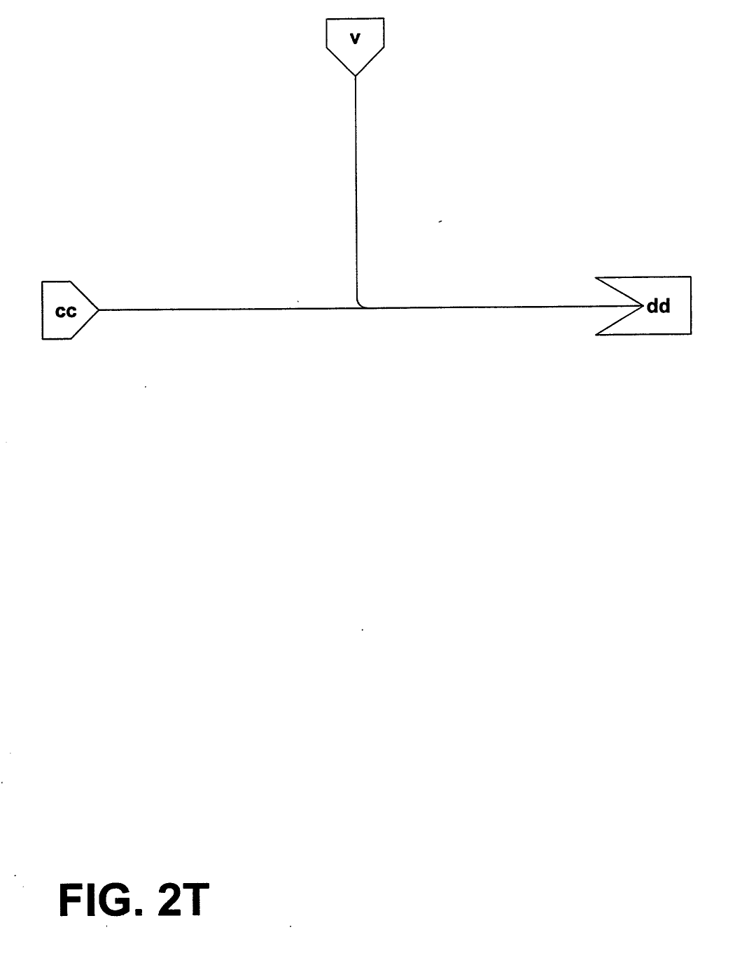

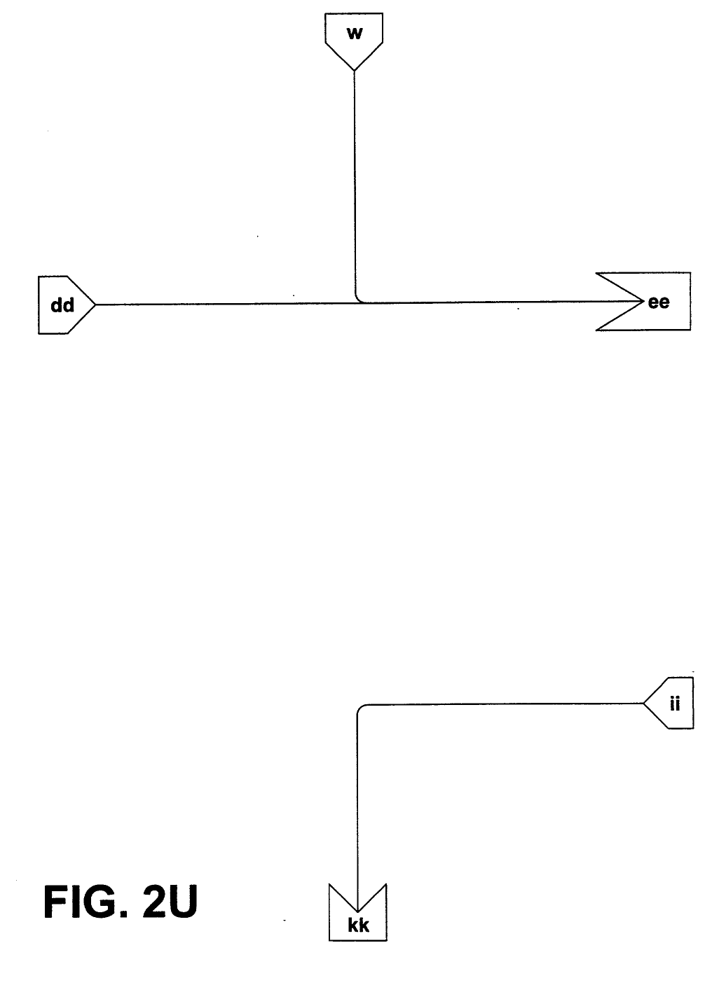

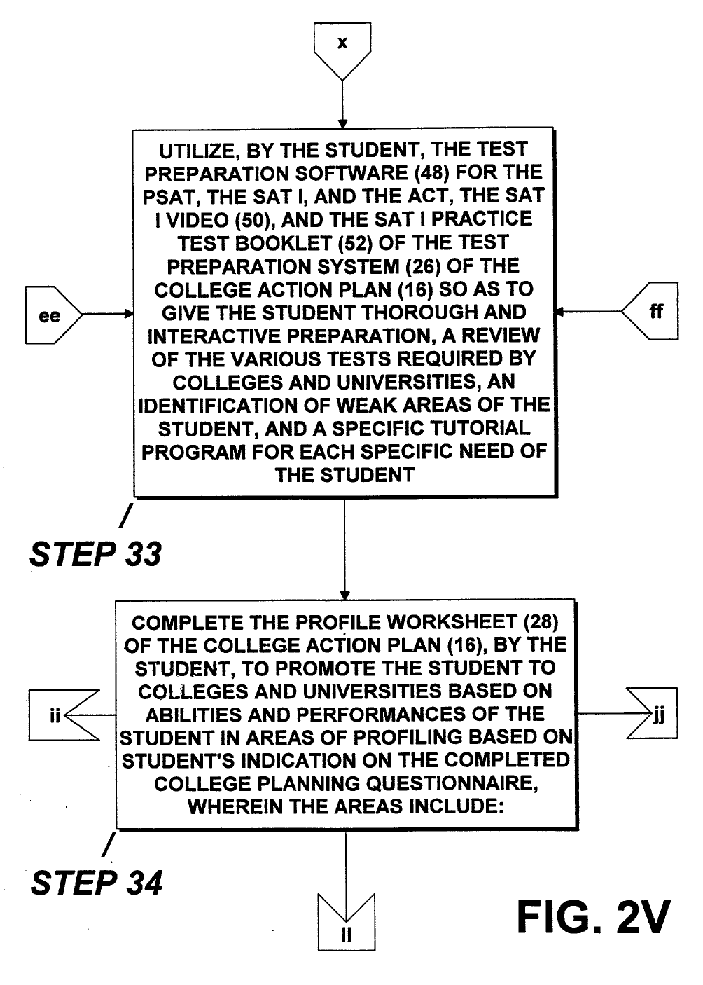

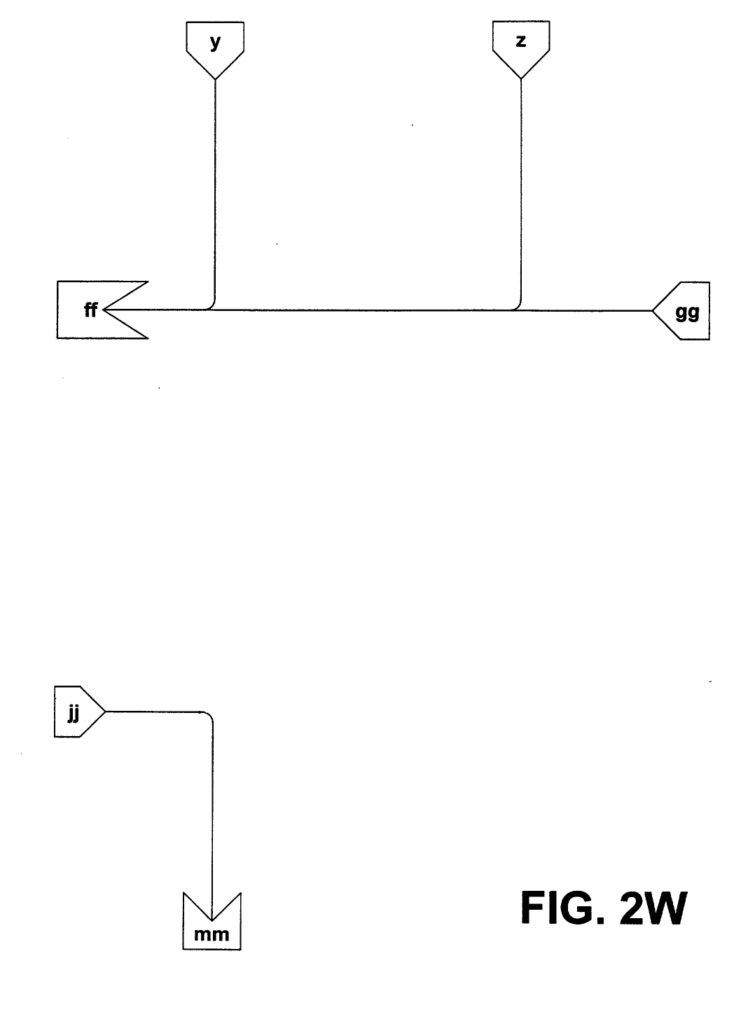

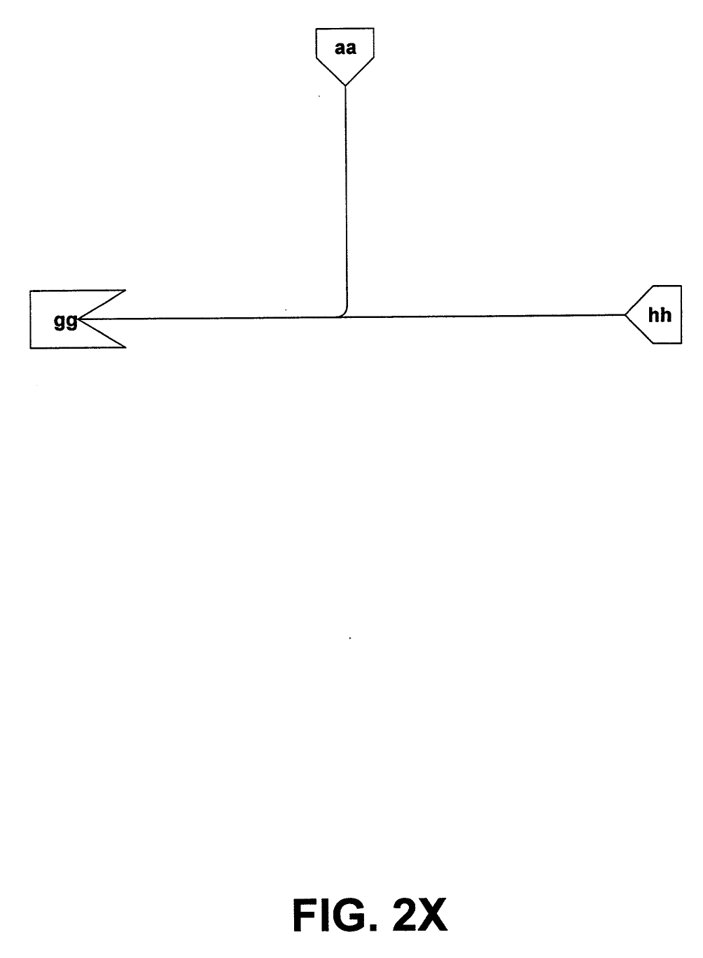

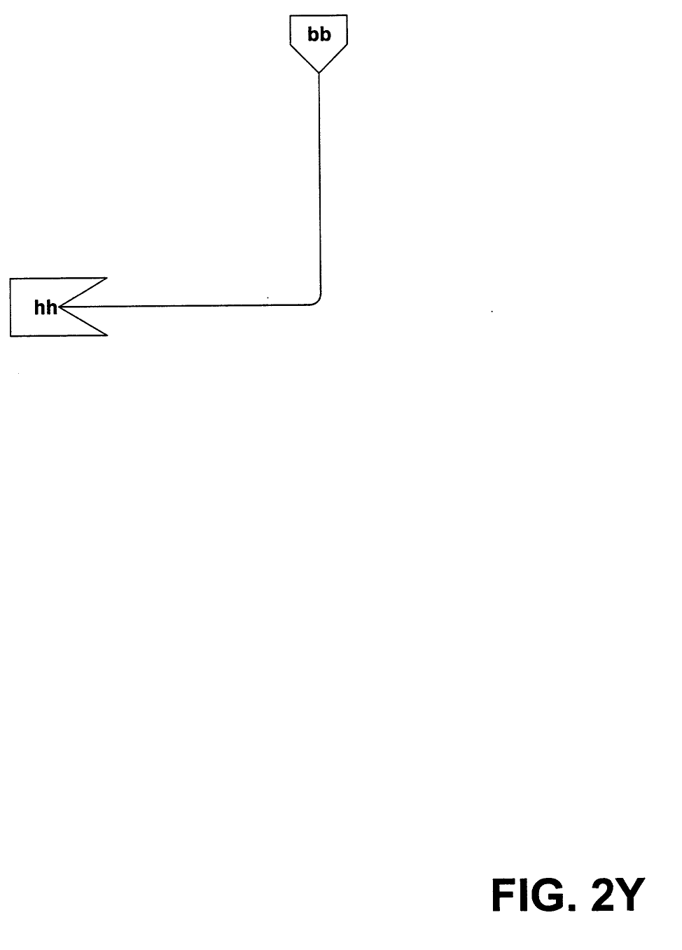

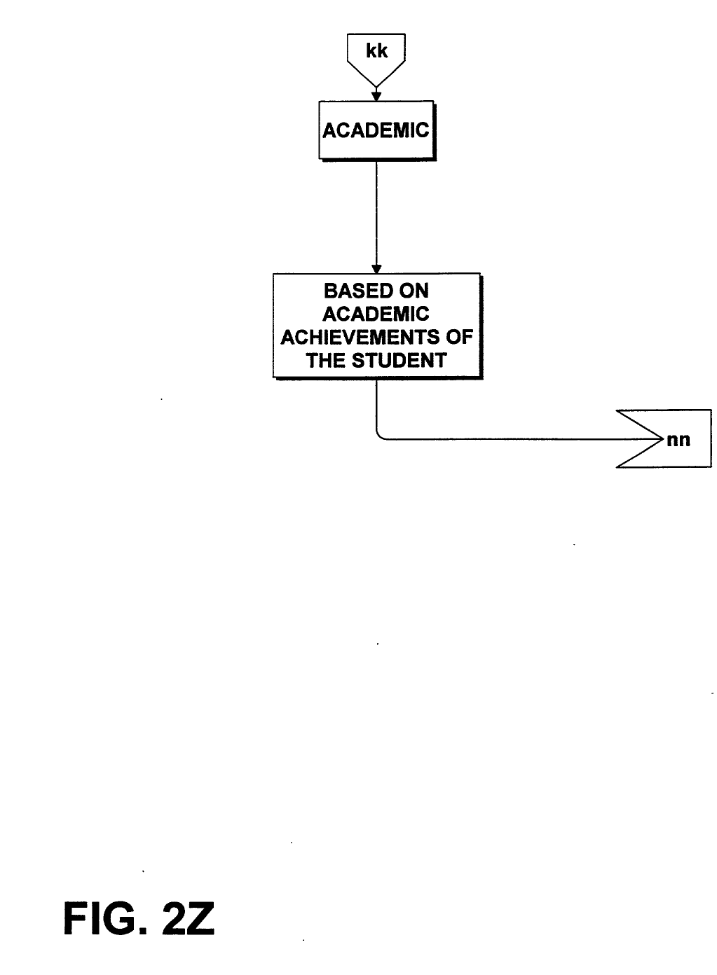

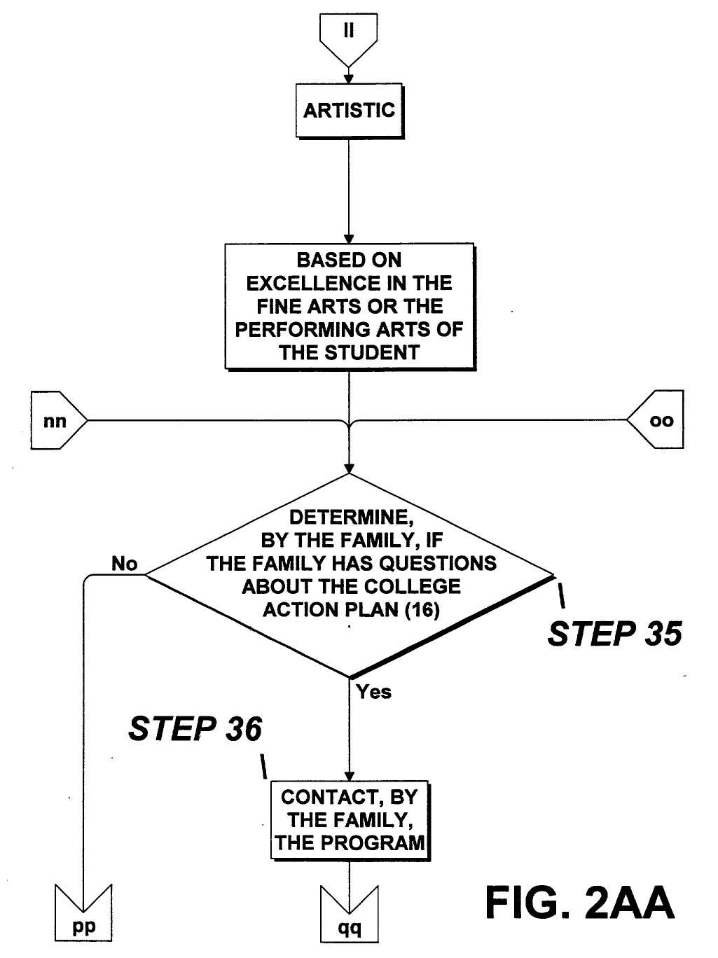

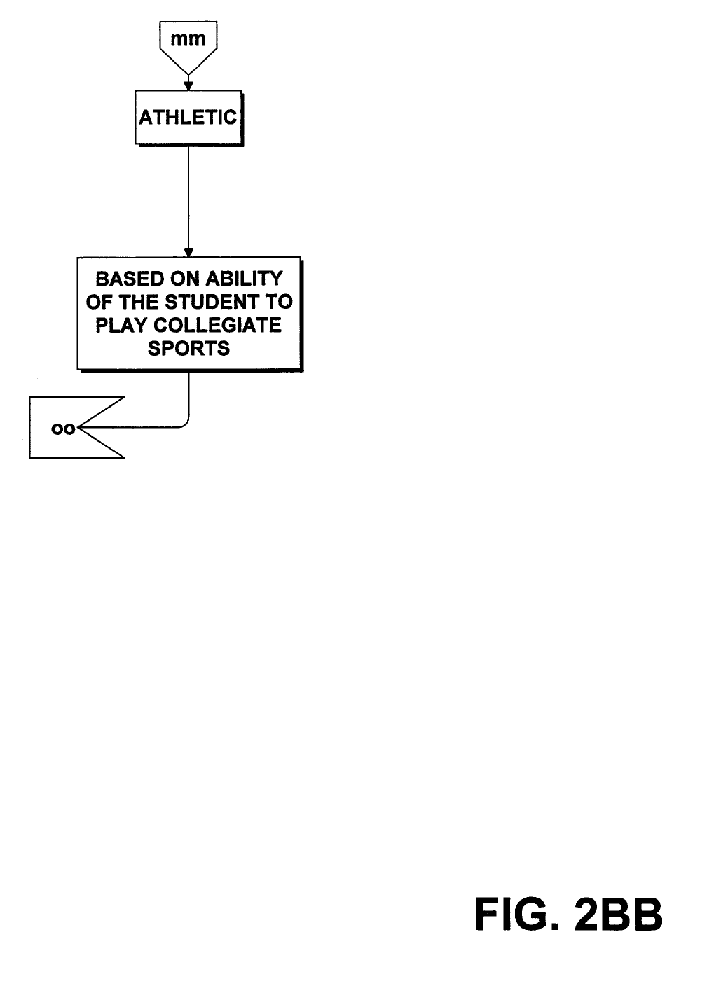

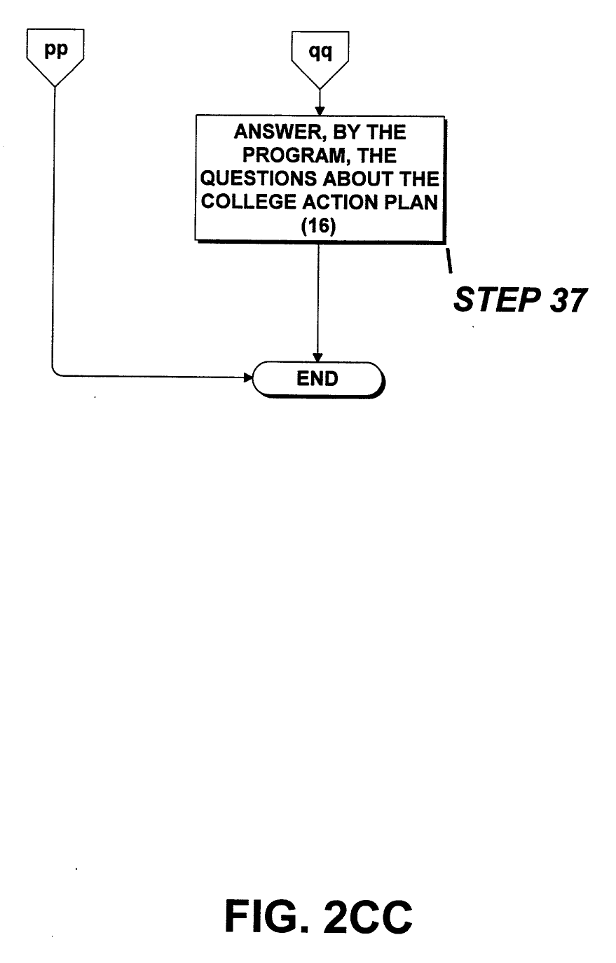

The method for utilizing the system 10 for optimizing selection of a college or a university by a program can best be seen in FIG. 2A-2CC, which are a process flow chart of the method of the present invention for utilizing the system for optimizing selection of a college or university of the present invention shown in FIG. 1A-1DDD, and as such, will be discussed with reference thereto.

STEP 1: Enroll, by the family, in the program.

STEP 2: Receive, by the family from the program, the college planning questionnaire software 14 and the college planning questionnaire 12.

STEP 3: Utilize, by the student, the college planning questionnaire software 14 to assist in filling out the college planning questionnaire 12, by virtue of the college planning questionnaire software 14 conducting a battery of tests in order to perform a thorough analysis of the likes and dislikes of the student and help the student identify appropriate areas of interest or specific college majors so as to form results.

STEP 4: Compare, by the college planning questionnaire software 14, the results of the student with corresponding college majors and potential career choices.

STEP 5: Print the printable report 21, by the college planning questionnaire software 14, after completing each test to allow the student to evaluate his/her interests and have information about appropriate careers, annual income, industry outlook, and a brief job description of all the different careers.

STEP 6: Transfer, by the student, the results to the student section 20 of the college planning questionnaire 12.

STEP 7: Complete, by the student, the student section 20 of the college planning questionnaire 12, and complete, by the parents, the parents section 18 of the college planning questionnaire 12 so as to form a completed college planning questionnaire which collects information from the family including information about the interests, aptitude, abilities, talents, and college selection preferences of the student and critical information about the finances of the family from both the parents and the student.

STEP 8: Mail, by the family to the program, the completed college planning questionnaire.

STEP 9: Receive, by the program from the family, the completed college planning questionnaire.

STEP 10: Log in, by the program, the completed college planning questionnaire.

STEP 11: Input, by the program, the completed college planning questionnaire into a database.

STEP 12: Create, by the program, the college action plan 16 which takes the family through the entire college transition process by utilizing the information from the completed college planning questionnaire.

STEP 13: Review, by the program, the college action plan 16.

STEP 14: Determine, by the program, if additional information is needed.

STEP 15: Provide, by the family to the program, the additional information, if answer to STEP 14 is yes and proceed directly to STEP 17.

STEP 16: Proceed directly to STEP 17, if answer to STEP 14 is no.

STEP 17: Conduct, by the program, a final quality assurance of the college action plan 16.

STEP 18: Mail, by the program to the family, the college action plan 16.

STEP 19: Document, by the program, the event.

STEP 20: Produce, by the program, appropriate reports.

STEP 21: Receive, by the family from the program, the college action plan 16.

STEP 22: Read, by the family, the hard copy 22 of the college action plan 16.

STEP 23: Watch, by the family, the video 24 of the college action plan 16.

STEP 24: Utilize, by the family, the action item checklist 32 at the end of each section of the hard copy 22 of the college action plan 16 to assist the family in their progress through the college action plan 16.

STEP 25: Utilize, by the family, the financial aid section 38 of the college action plan 16 to provide the family with a detailed look at their current financial situation as it relates to paying for the college or the university by providing an initial financial analysis and an expected family contribution as well as by educating the family about how the expected family contribution will be calculated so that the family can take a proactive approach and maximize a financial aid package through all available avenues.

STEP 26: Recommend, by the financial aid section 38, specific strategies that the family could apply which may help lower their expected financial contribution so as to form recommended strategies.

STEP 27: Illustrate, by the financial aid section, an adjusted statement of income and assets showing what the expected family contribution should look like if the family applied the recommended strategies.

STEP 28: Determine, by the family, if the recommended strategies are to applied.

STEP 29: Apply, by the family, the recommended strategies, if answer to STEP 28 is yes and proceed directly to STEP 31.

STEP 30: Proceed directly to STEP 31, if answer to STEP 28 is no.

STEP 31: Illustrate the list 42 in the college selection section 40 of the college action plan 16, in order of affordability, 25 colleges and/or universities selected from a list of more than two thousand 4-year colleges and universities that best fit the needs of the student based on the information from the completed college planning questionnaire including the student's GPA, test scores, as well as their individual preferences specific states, specific majors, public/private, large, small, etc.

STEP 32: Illustrate, by the college selection section 40, the detailed two-page analysis 44 of each college or university listed so that the family can make decisions about the merits of each college or university, wherein each two-page analysis 44 includes a description of the college or university, the faculty and the student body at the college or university, the admission and academic programs detailing the requirements a student must meet in order to be eligible for acceptance to the college or university, the available student activities and services including descriptions of available housing facilities and computer labs at the college or university, available intercollegiate and intramural athletics at the college or university, the scores needed on advanced placement tests to generate college credit at the college university, and a financial overview of the college or university including what the student's specific out-of-pocket costs would be so as to provide a standardized cost of attendance so as to ensure that the family is comparing true costs and information about the amount of gift aid and self-help aid versus work-study and loans that is historically available based on the family's specific expected financial contribution.

STEP 33: Utilize, by the student, the test preparation software 48 for the PSAT, the SAT I, and the ACT, the SAT I video 50, and the SAT I practice test booklet 52 of the test preparation system 26 of the college action plan 16 so as to give the student thorough and interactive preparation, a review of the various tests required by colleges and universities, an identification of weak areas of the student, and a specific tutorial program for each specific need of the student.

STEP 34.: Complete the profile worksheet 28 of the college action plan 16, by the student, to promote the student to colleges and universities based on the abilities and performances of the student in areas of profiling based on the student's indication on the completed college planning questionnaire, wherein the areas include academic based on the academic achievements of the student, artistic based on the excellence in the fine arts or the performing arts of the student, and athletic based on the ability of the student to play collegiate sports.

STEP 35: Determine, by the family, if the family has questions about the college action plan 16.

STEP 36: Contact, by the family, the program, if answer to STEP 35 is yes.

STEP 37: Answer, by the program, the questions about the college action plan 16, if STEP 36 is implemented.

It will be understood that each of the elements described above, or two or more together, may also find a useful application in other types of constructions differing from the types described above.

While the invention has been illustrated and described as embodied in a system for optimizing selection of a college or a university and a method for utilizing the system, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A system for optimizing selection of a college or a university for a student with parents forming a family, said system comprising:
a) a college planning questionnaire;
b) college planning questionnaire software; and
c) a college action plan;
wherein said college planning questionnaire collects important data from the family including information about interests of the student, aptitude of the student, abilities of the student, talents of the student, and selection preferences of the college or the university of the student;
wherein said college planning questionnaire collects critical information about the finances of the family from both the parents and the student;
wherein said college planning questionnaire software assists the student in filling out said college planning questionnaire by helping the student identify appropriate areas of interest or specific college majors by virtue of said college planning questionnaire software interactively conducting a battery of tests in order to perform a thorough analysis of the likes and dislikes of the student so as to form choices;
wherein said college action plan is designed to take the family through the entire college transition process; and
wherein said college action plan is created by information from said college planning questionnaire.

2. The system as defined in claim 1, wherein said college action plan includes only colleges and universities offering degrees in the student's specific college majors.

3. The system as defined in claim 1, wherein said college planning questionnaire is an extensive multi-page document.

4. The system as defined in claim 1, wherein said college planning questionnaire includes a parents section;
wherein said parents section is completed by the parents;
wherein said college planning questionnaire includes a student section; and
wherein said student section is completed by the student.

5. The system as defined in claim 1, wherein said college planning questionnaire software compares said choices with corresponding college majors and potential career choices.

6. The system as defined in claim 1, wherein said college planning questionnaire software is a CD.

7. The system as defined in claim 1, wherein a printable report is available after completing each of said battery of tests;
wherein said report allows the student to evaluate his/her interests;
wherein said report provides information about how to select an appropriate college major or area of interest; and
wherein said report includes information about appropriate careers, annual income, industry outlook, and a brief job description of all different careers.

8. The system as defined in claim 1, wherein said college action plan comprises a hard copy;
wherein said college action plan comprises a video; and
wherein said college action plan comprises a profile worksheet.

9. The system as defined in claim 1, wherein said college action plan comprises a test preparation system.

10. The system as defined in claim 8, wherein said hard copy of said college action plan includes major sections;
wherein said hard copy of said college action plan includes an action item checklist at the end of each of said major sections to assist the family in tracking their progress through said college action plan; and
wherein said hard copy of said college action plan includes an appendix.

11. The system as defined in claim 10, wherein said major sections include two main sections;
wherein said two main sections are unique to each family; and
wherein said two main sections provide customized data provided from information from said college planning questionnaire.

12. The system as defined in claim 11, wherein said two main sections include a financial aid section; and
wherein said two main sections include a college selection section.

13. The system as defined in claim 12, wherein said financial aid section is designed to help maximize a family's financial aid package through all available avenues as well as by educating the family about how an expected family contribution will be calculated so that the family can take a proactive approach;
wherein said financial aid section provides the family with a detailed look at their current financial situation as it relates to paying for the college or the university;
wherein said financial aid section provides the family with an initial financial analysis and the expected family contribution;
wherein said financial aid section provides a true cost of attendance;
wherein said financial aid section lists types and amounts of financial aid typically offered;
wherein said financial aid section recommends specific strategies that the family could apply which may help lower the expected family contribution so as to form recommended strategies; and
wherein said financial aid section illustrates an adjusted statement of income and assets that the expected family contribution should look like if the family applied said recommended strategies.

14. The system as defined in claim 12, wherein said college selection section provides a list of colleges and/or universities;
wherein said list of colleges and/or universities are selected from a list of more than two thousand 4-year colleges and universities that best fit the needs of the student based on answers of the student on said college planning questionnaire;
wherein said list of colleges and/or universities are listed in order of affordability;
wherein said list of colleges and/or universities takes into consideration GPA, test scores, as well as individual preferences of the student; and
wherein the first entry on said list of colleges and/or universities is the college or the university that most closely matches the interests of the student and has the lowest out-of-pocket cost.

15. The system as defined in claim 12, wherein said college selection section provides a detailed analysis of each college and/or university listed on said list of colleges and/or universities so that the family can make decisions about the merits of each college and/or university.

16. The system as defined in claim 15, wherein each detailed analysis includes a description of the college or the university;
wherein each detailed analysis includes the faculty and the student body at the college or the university;
wherein each detailed analysis includes admission and academic programs detailing the requirements the student must meet in order to be eligible for acceptance at the college or the university;
wherein each detailed analysis includes available student activities and services including descriptions of available housing facilities and computer labs at the college or the university;
wherein each detailed analysis includes available intercollegiate and intramural athletics at the college or the university;
wherein each detailed analysis includes scores needed on advanced placement tests to generate college credit at the college or the university; and
wherein each detailed analysis includes an overview of financial aid offerings of the college or the university including what specific out-of-pocket costs there would be, standardized cost of attendance so as to ensure that the family compares true costs, information about amount of gift aid and self-help aid that is historically available based on the expected family contribution, and how much is historically given in funding that the family will not have to pay back versus funding the family will have to pay back or earn.

17. The system as defined in claim 10, wherein said appendix of the hard copy includes short sections.

18. The system as defined in claim 8, wherein said video of said college action plan provides an overview of said hard copy of said college action plan.

19. The system as defined in claim 9, wherein said test preparation system of said college action plan is designed to give the student thorough and interactive preparation;
wherein said test preparation system provides a review of various tests required by colleges and universities; and
wherein said test preparation system identifies weak areas of the student and arranges a specific tutorial program for each specific need of the student.

20. The system as defined in claim 9, wherein said test preparation system of said college action plan includes test preparation software for the PSAT, the SAT I, and the ACT;
wherein said test preparation system of said college action plan includes a SAT I video; and
wherein said test preparation system of said college action plan includes a SAT I practice test booklet.

21. The system as defined in claim 20, wherein said test preparation software is a CD.

22. The system as defined in claim 8, wherein said profile worksheet of said college action plan promotes the student to colleges and universities based on abilities and performances of the student in an area of profiling.

23. The system as defined in claim 22, wherein said area of profiling is based on student's indication on said college planning questionnaire;
wherein said area of profiling includes academic;
wherein said academic is based on academic achievements of the student;
wherein said area of profiling includes artistic;
wherein said artistic is based on excellence in the fine arts or the performing arts of the student;
wherein said area of profiling includes athletic; and
wherein said athletic is based on ability of the student to play collegiate sports.

24. A method of optimizing selection of a college or a university for a student with parents forming a family by utilizing a system provided by a program, wherein the system includes college planning questionnaire software, a college planning questionnaire having a student portion and a parents portion, and a college action plan having a hard copy with a financial aid section, a college selection section with a list of colleges and/or universities, and a detailed analysis, and a video, said method comprising the steps of:
a) enrolling, by the family, in the program;
b) receiving, by the family from the program, the college planning questionnaire software and the college planning questionnaire;
c) utilizing, by the student, the college planning questionnaire software to assist in filling out the college planning questionnaire;
d) completing, by the student, the student section of the college planning questionnaire, and completing, by the parents, the parents section of the college planning questionnaire so as to form a completed college planning questionnaire;
e) creating, by the program, the college action plan by utilizing information from the completed college planning questionnaire;
f) taking, by the college action plan, the family through the entire college transition process;
g) reading, by the family, the hard copy of the college action plan;
h) watching, by the family, the video of the college action plan;
i) utilizing, by the family, the financial aid section of the college action plan to provide the family with a detailed look at their current financial situation as it relates to paying for the college or the university;
j) illustrating in the college selection section of the college action plan, in order of affordability, the list of colleges and/or universities selected from a list of more than two thousand 4-year colleges and universities that best fit the needs of the student; and
k) illustrating, by the college selection section, the detailed analysis of each college and/or university listed so that the family can make decisions about the merits of each college and/or university.

25. The method as defined in claim 24, wherein said step of utilizing, by the student, the college planning questionnaire software to assist in filling out the college planning questionnaire includes utilizing, by the student, the college planning questionnaire software to assist in filling out the college planning questionnaire by virtue of the college planning questionnaire software conducting a battery of tests in order to perform a thorough analysis of the likes and dislikes of the student and help the student identify appropriate areas of interest or specific college majors so as to form results.

26. The method as defined in claim 25, further comprising the step of comparing, by the college planning questionnaire software, the results of the student with corresponding college majors and potential career choices.

27. The method as defined in claim 24, wherein said step of completing, by the student, the student section of the college planning questionnaire, and completing, by the parents, the parents section of the college planning questionnaire so as to form a completed college planning questionnaire includes completing, by the student, the student section of the college planning questionnaire, and completing, by the parents, the parents section of the college planning questionnaire so as to form a completed college planning questionnaire that collects information from the family including information about the interests, aptitude, abilities, talents, and college selection preferences of the student and critical information about the finances of the family from both the parents and the student.

28. The method as defined in claim 24, wherein said step of illustrating, by the college selection section, the detailed analysis of each college and/or university listed so that the family can make decisions about the merits of each college and/or university includes illustrating, by the college selection section, the detailed two-page analysis of each college and/or university that includes a description of the college or university, the faculty and the student body at the college or university, admission and academic programs detailing the requirements a student must meet in order to be eligible for acceptance to the college or university, available student activities and services including descriptions of available housing facilities and computer labs at the college or university, available intercollegiate and intramural athletics at the college or university, scores needed on advanced placement tests to generate college credit at the college or university, and a financial overview of the college or university including what the student's specific out-of-pocket costs would be so as to provide a standardized cost of attendance so as to ensure that the family is comparing true costs, and information about the amount of gift aid and self-help aid versus work-study and loans that is historically available at the college or university based on the family's specific expected financial contribution.

29. The method as defined in claim 24, wherein said step of utilizing, by the family, the financial aid section of the college action plan to provide the family with a detailed look at their current financial situation as it relates to paying for the college or the university includes utilizing, by the family, the financial aid section of the college action plan to provide the family with a detailed look at their current financial situation as it relates to paying for the college or the university by providing an initial financial analysis and an expected family contribution as well as by educating the family about how the expected family contribution will be calculated so that the family can take a proactive approach and maximize a financial aid package through all available avenues.

30. The method as defined in claim 24, wherein said step of illustrating the list in the college selection section of the college action plan, in order of affordability, colleges and/or universities selected from a list of more than two thousand 4-year colleges and universities that best fit the needs of the student includes illustrating the list in the college selection section of the college action plan, in order of affordability, colleges and/or universities selected from a list of more than two thousand 4-year colleges and universities that best fit the needs of the student based on information from the completed college planning questionnaire including the student's GPA, test scores, as well as the student's individual preferences.

31. The method as defined in claim 24, wherein the hard copy of the college action plan further includes an action item checklist at the end of each section thereof, and wherein said method further comprises the step of utilizing, by the family, the action item checklist at the end of each section of the hard copy of the college action plan to assist the family in their progress through the college action plan.

32. The method as defined in claim 24, wherein the college planning questionnaire software further has a printable report, and wherein said method further comprises the step of printing the printable report, by the college planning questionnaire software, after completing each test to allow the student to evaluate their interests and have information about appropriate careers, annual income, industry outlook, and a brief job description of all the different careers.

33. The method as defined in claim 24, wherein the program has a database, and wherein said method further comprises the steps of:
a) logging in, by the program, the completed college planning questionnaire;
b) inputting, by the program, the completed college planning questionnaire into the database;
c) reviewing, by the program, the college action plan;
d) determining, by the program, if additional information is needed;
e) providing, by the family to the program, the additional information, if answer to step d) is yes and proceeding directly to step g);
f) proceeding directly to step g) if answer to step d) is no;
g) conducting, by the program, a final quality assurance of the college action plan;
h) mailing, by the program to the family, the college action plan;
i) documenting, by the program, said mailing step; and
j) producing, by the program, appropriate reports after said mailing step.

34. The method as defined in claim 24, further comprising the steps of:
a) recommending, by the financial aid section, specific strategies that the family could apply which may help lower their expected financial contribution so as to form recommended strategies;
b) illustrating, by the financial aid section, an adjusted statement of income and assets showing what the expected family contribution should look like if the family applied the recommended strategies;
c) determining, by the family, if the recommended strategies are to applied;
d) applying, by the family, the recommended strategies, if answer to step c) is yes; and
e) not applying, by the family, the recommended strategies, if answer to step c) is no.

35. The method as defined in claim 24, wherein the college action plan has a test preparation system with test preparation software for the PSAT, the SAT I, and the ACT, a SAT I video, and a SAT I practice test booklet; and wherein said method further comprises the step of utilizing, by the student, the test preparation software for the PSAT, the SAT I, and the ACT, the SAT I video, and the SAT I practice test booklet of the test preparation system to give the student thorough and interactive preparation, a review of the various tests required by colleges and universities, an identification of weak areas of the student, and a specific tutorial program for each specific need of the student.

36. The method as defined in claim 24, wherein the college action plan has a profile worksheet; and
wherein said method further comprises the step of completing the profile worksheet, by the student, to promote the student to colleges and universities based on abilities and performances of the student in areas of profiling based on student's indication on the completed college planning questionnaire.

37. The method as defined in claim 36, wherein said step of completing the profile worksheet of the college action plan, by the student, to promote the student to colleges and universities based on abilities and performances of the student in areas of profiling based on student's indication on the completed college planning questionnaire includes completing the profile worksheet of the college action plan, by the student, to promote the student to colleges and universities based on abilities and performances of the student in areas of profiling that include academic based on academic achievements of the student, artistic based on excellence in the fine arts or the performing arts of the student, and athletic based on ability of the student to play collegiate sports.
